(19) United States
(12) Patent Application Publication
(10) Pub. No.: US 2019/0327425 A1
(43) Pub. Date: Oct. 24, 2019

(54) IMAGE PROCESSING DEVICE, METHOD AND PROGRAM

(71) Applicant: SONY CORPORATION, TOKYO (JP)

(72) Inventors: YOSHIYUKI KOBAYASHI, TOKYO (JP); TOSHIYA HAMADA, SAITAMA (JP)

(21) Appl. No.: 16/470,844

(22) PCT Filed: Jan. 17, 2018
(86) PCT No.: PCT/JP2018/001094

§ 371 Date: Jun. 18, 2019

(30) Foreign Application Priority Data
Jan. 30, 2017 (JP) 2017-014120

(51) Int. Cl. H04N 5/262; H04N 19/172; G06K 9/00; H04N 19/517

(52) U.S. Cl. CPC H04N 5/2627; H04N 19/517; G06K 9/00765; H04N 19/172

(57) ABSTRACT

The present technology relates to an image processing device and a method and a program capable of suppressing disharmony during switching of moving images more easily. An image processing device includes: a moving image generating unit that generates moving image data of a transition moving image in which display transitions from a prescribed frame to a second moving image on the basis of the prescribed frame that forms a first moving image and moving image data of the second moving image in a case where display is switched from the first moving image to the second moving image. The present technology can be applied to a client apparatus.

### TECHNICAL FIELD

The present technology relates to an image processing device and a method and a program, and particularly, to an image processing device and a method and a program capable of suppressing disharmony during switching of moving images more easily.

### BACKGROUND ART

A feature of moving picture experts group phase-dynamic adaptive streaming over HTTP (MPEG-DASH) is streaming reproduction of a reproduction device-based optimal representation selection method called bit rate adaptation (for example, see Non-Patent Document 1).

For example, during streaming reproduction, a reproduction device automatically selects moving image data of an optimal bit rate according to the state of a network bandwidth from the moving image (video) of a plurality of representations having different bit rates.

When a representation is selected, moving image data of contents is switched in units called segments according to the selection. In this case, since the video itself of respective representations is the same, a scene change does not occur at a switching point of segments and the video is continued seamlessly.

In such MPEG-DASH streaming reproduction, there is a situation in which a video transition effect of a moving image is useful. For example, it is when a plurality of adaptation sets of a moving image is defined and representations of respective adaptation sets are moving images captured from independent viewpoints.

A user autonomously selects a video (moving image) of a viewpoint preferred by the user from a plurality of representations of different viewpoints. In this case, for example, if transition (switching) from a prescribed viewpoint to another viewpoint occurs, a segment boundary is a video switching point and the video becomes non-seamless.

When such a scene change occurs, a video presented to a user changes abruptly, which gives disharmony to the user at the scene change portion. Therefore, generally, disharmony occurring due to non-seamless video transition is alleviated by applying a video transition effect technology such as cross-fade or wipe which is one of video editing processes.

For example, as for a video transition effect technology, a technology defined in SMPTE Standard 258M or the like may be used.

However, in order to apply a video transition effect to a moving image, a reproduction device needs to process two moving images of a fade-out-side moving image and a fade-in-side moving image in a video transition effect application section.

Therefore, the load on the reproduction device increases when a video transition effect technology is applied to MPEG-DASH moving image reproduction.

That is, first, for a segment of the same time point, segment data of a source moving image and segment data of a destination moving image need to be downloaded. That is, segment data of the same time point needs to be downloaded redundantly.

Moreover, since two pieces of segment data are handled simultaneously, the number of processes of a reproduction device increases. Particularly, the number of processes associated with video decoding increases.

Therefore, a technology in which, for example, a server (that is, a contents provider) generates an image to which a video transition effect is applied as a transition image in advance is proposed (for example, see Patent Document 1). When such a transition image is used, it is possible to suppress disharmony during switching of moving images while suppressing the number of processes or the like on a reproduction device side.

### CITATION LIST

### Non-Patent Document

Non-Patent Document 1: ISO/IEC 23009-1:2014 Information technology—Dynamic adaptive streaming over HTTP (DASH)—Part 1: Media presentation description and segment formats

### Patent Document

Patent Document 1: Japanese Patent Application Laid-Open No. 2015-73156

### SUMMARY OF THE INVENTION

### Problems to be Solved by the Invention

However, in the above-described technology, it is difficult to suppress disharmony during switching of moving images easily.

Specifically, in the technology in which a server prepares a transition image in advance, in a case where moving images of respective viewpoints, for example, are defined as representations, it is necessary to prepare transition images for a combination of a prescribed viewpoint and another viewpoint. In this case, since it is necessary to prepare transition images for all combinations of possible viewpoints, a large number of processes are necessary for generating transition images as the number of viewpoints increases, and management of transition images and the like becomes complicated.

The present technology has been made in view of the above-described problems and aims to suppress disharmony during switching of moving images more easily.

### Solutions to Problems

An image processing device according to an aspect of the present technology includes: a moving image generating unit that generates moving image data of a transition moving image in which display transitions from a prescribed frame to a second moving image on the basis of the prescribed frame that forms a first moving image and moving image data of the second moving image in a case where display is switched from the first moving image to the second moving image.

The image processing device may further include: a decoder that decodes the moving image data of the first moving image and the second moving image; a first storage unit that stores the prescribed frame obtained by the decoding; and a second storage unit that stores frames of the first moving image or the second moving image obtained by the decoding.

The moving image generating unit may use a last frame in time before switching of the first moving image as the prescribed frame.

The decoder may store a last frame of the first moving image of a prescribed time unit in the first storage unit as the prescribed frame in a period other than an effect period in which the moving image data of the transition moving image is generated for the first moving image of the prescribed time unit.

The decoder may store a frame of the first moving image output first after a predetermined frame of the second moving image is input in the first storage unit as the prescribed frame.

The moving image generating unit may generate the moving image data of the transition moving image in which display transitions from the prescribed frame to the second moving image more abruptly on a starting side than an ending side.

The image processing device may further include a representative frame determining unit that determines a representative frame among a plurality of frames that forms the first moving image on the basis of information related to an emotional value of the first moving image, and the moving image generating unit may use the representative frame as the prescribed frame.

The representative frame determining unit may determine the representative frame on the basis of a score indicating an emotional value of frames of the first moving image as the information related to the emotional value.

The representative frame determining unit may determine the representative frame on the basis of recommended frame information indicating a frame recommended as the representative frame of the first moving image as the information related to the emotional value.

The representative frame determining unit may determine the representative frame in a prescribed time unit for the first moving image, and in a case where a frame indicated by the recommended frame information is a frame outside a valid period including a terminating end of the first moving image of the prescribed time unit, the representative frame determining unit may determine the representative frame from frames within a period including successive frames including the terminating end of the first moving image of the prescribed time unit on the basis of a score indicating an emotional value of frames of the first moving image as the information related to the emotional value.

The representative frame determining unit may acquire information related to the emotional value from a stream in which moving image data of the first moving image is stored.

An image processing method or a program according to an aspect of the present technology includes: a step of generating moving image data of a transition moving image in which display transitions from a prescribed frame to a second moving image on the basis of the prescribed frame that forms a first moving image and moving image data of the second moving image in a case where display is switched from the first moving image to the second moving image.

In an aspect of the present technology, moving image data of a transition moving image in which display transitions from a prescribed frame to a second moving image on the basis of the prescribed frame that forms a first moving image and moving image data of the second moving image in a case where display is switched from the first moving image to the second moving image is generated.

### Effects of the Invention

According to an aspect of the present technology, it is possible to suppress disharmony during switching of moving images more easily.

Note that the above-described effects are not necessarily limitative but may be any one of the effects described in the present disclosure.

### BRIEF DESCRIPTION OF DRAWINGS

FIG. 1 is a diagram illustrating a video transition effect.

FIG. 2 is a diagram illustrating a configuration example of a client apparatus.

FIG. 3 is a flowchart illustrating a streaming reproduction process.

FIG. 4 is a flowchart illustrating a video segment downloading process.

FIG. 5 is a flowchart illustrating a video segment process.

FIG. 6 is a flowchart illustrating a video decoding process.

FIG. 7 is a flowchart illustrating a video transition effect execution process.

FIG. 8 is a diagram illustrating an example of a blending ratio of alpha blending.

FIG. 9 is a diagram illustrating an example of a blending ratio of alpha blending.

FIG. 10 is a diagram illustrating an example of display switching and a video transition effect.

FIG. 11 is a diagram illustrating an example of display switching and a video transition effect.

FIG. 12 is a flowchart illustrating a video segment process.

FIG. 13 is a flowchart illustrating a video decoding process.

FIG. 14 is a diagram illustrating an example of display switching and a video transition effect.

FIG. 15 is a diagram illustrating an example of display switching and a video transition effect.

FIG. 16 is a diagram illustrating an example of representative frame information.

FIG. 17 is a flowchart illustrating a video segment process.

FIG. 18 is a diagram illustrating a configuration example of a computer.

### MODE FOR CARRYING OUT THE INVENTION

Hereinafter, an embodiment to which the present technology is applied will be described with reference to the drawings.

### First Embodiment <About Present Technology>

The present technology aims to suppress disharmony during switching of moving images more easily by executing a video transition effect using a moving image and a still image (that is, one video frame) that can be stored as a snapshot of the moving image.

For example, the present technology can be applied in a case where a video transition effect is executed between a source moving image and a destination moving image during transition of representations in MPEG-DASH streaming reproduction. In this case, a video transition effect is executed on the basis of the destination moving image and a frame near a terminating end of a segment of the source moving image, and a transition moving image in which the display transitions from the frame of the source moving image to the destination moving image is generated.

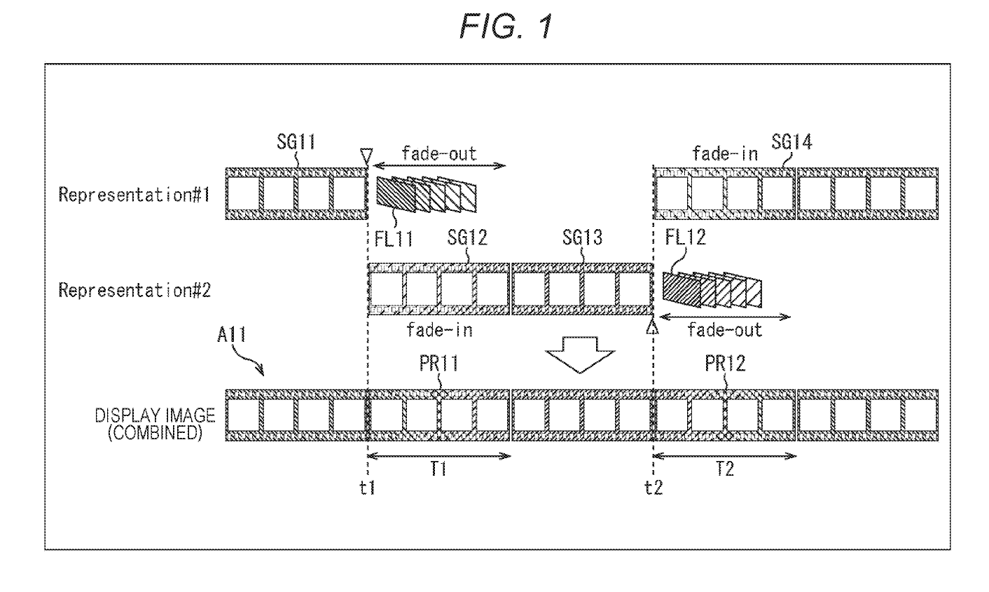

For example, as illustrated in FIG. 1, it is assumed that there are a moving image of Representation#1 and a moving image of Representation#2 of different viewpoints, and the display (that is, a viewpoint) is switched at time points t1 and t2. Moreover, a moving image indicated by an arrow A11 indicates a presentation moving image presented to a user.

In this example, the moving image of Representation#1 is reproduced until time point t1, and it is instructed such that the display is switched to the moving image of Representation#2 at time point t1.

In this case, cross-fade is executed using a last frame FL11 of a segment SG11 of Representation#1 of which the terminating end is time point t1 and a moving image of a segment SG12 of Representation#2 which starts at time point t1 whereby a presentation moving image PR11 of a period of T1 is generated.

In this case, the last frame FL11 is stored, and a cross-fade process as a video transition effect is performed continuously in time between the last frame FL11 and the moving image of the segment SG12 whereby a moving image PR11 which is a transition moving image is generated. Particularly, in this example, the moving image of the segment SG11 is a source moving image, and the moving image of the segment SG12 is a destination moving image. Moreover, the moving image PR11 is a transition moving image in which the display transitions from the last frame FL11 to the moving image of the segment SG12 with time.

In the period T1 subsequent to time point t1, the moving image PR11 obtained in this manner is displayed.

The moving image PR11 is a moving image in which the last frame FL11 is displayed at time point t1, and after that, the displays transitions gradually from the last frame FL11 to the moving image of the segment SG12. In other words, the moving image PR11 is a moving image in which the last frame FL11 fades out and the moving image of the segment SG12 fades in.

Due to this, it is possible to suppress disharmony during switching as compared to a case in which the display is switched from the moving image of Representation#1 to the moving image of Representation#2 without executing a video transition effect.

Note that, hereinafter, a period in which a video transition effect is executed within a moving image reproduction period such as the period T1 of this example will be referred particularly to as an effect period.

Moreover, after the period T1, when a moving image of a segment SG13 of Representation#2 is reproduced and an instruction to switch the display is issued at time point t2, the same moving image PR12 as the moving image PR11 is generated, and the moving image PR12 is reproduced in a period T2 subsequent to time point t2.

That is, cross-fade is executed using a last frame FL12 of a segment SG13 of Representation#2 of which the terminating end is time point t2 and a moving image of a segment SG14 of Representation#1 which starts at time point t2 whereby a presentation moving image PR12 of a period of T2 is generated.

By executing a video transition effect on the basis of the last frame (still image) of a source moving image and a destination moving image in this manner, it is possible to suppress disharmony during non-seamless switching of moving images easily with a small number of processes. Moreover, the server does not need to prepare a moving image to which a video transition effect is applied.

Furthermore, in this case, it is not necessary to download segment data of an effect period of the source moving image. Furthermore, since a still image is used as a source moving image, a process of decoding the source moving image of an effect period or the like is not necessary, and it is possible to reduce the number of processes as compared to the case of executing a video transition effect using two moving images.

Note that, although the case of executing a video transition effect process (that is, executing cross-fade as a video transition effect) of generating a moving image to be displayed in an effect period has been described as an example, the video transition effect process may be an arbitrary process such as a wipe process. For example, as for a video transition effect technology, a technology defined in SMPTE Standard 258M or the like may be used.

Moreover, although an example of using the last frame of a segment in a video transition effect has been described, the frame may not necessarily be the last frame as long as the frame is near the timing information of a segment.

As described above, in the present technology, a client that reproduces contents stores a prescribed frame of each segment which is a still image extracted from a segment. More specifically, the last frame of a segment is stored in a period other than the period in which a video transition effect is executed, which will be described later. Then, in a case where the display is switched from a source moving image to a destination moving image, a video transition effect process of realizing a video transition effect is performed on the basis of moving image data of the destination moving image and a prescribed frame (still image) of a last frame or the like of a last segment before switching of the source moving image, and moving image data of a transition moving image in which the display transitions from the prescribed frame of the source moving image to the destination moving image is generated.

Here, MPEG-DASH streaming reproduction will be described.

A reproduction device executes streaming data control software (hereinafter also referred to as control software), moving image reproduction software, hypertext transfer protocol (HTTP) access client software (hereinafter referred to as access software), and the like.

The control software is software that controls data that streams from a web server. For example, the control software acquires a media presentation description (MPD) file from the web server. Moreover, the control software sends a transmission request for reproduction target segment data to the access software on the basis of reproduction time information indicating a reproduction time or the like designated by the MPD file or the moving image reproduction software and a network bandwidth of the Internet.

The moving image reproduction software is software that reproduces an encoding stream acquired from the web server through the Internet. For example, the moving image reproduction software designates reproduction time information to the control software. Moreover, the moving image reproduction software decodes an encoding stream supplied from the access software upon acquiring a notification of the start of reception from the access software. The moving image reproduction software outputs video data (moving image data) and audio data obtained as the result of decoding.

The access software is software that controls communication with the web server using HTTP. For example, the access software supplies a notification of the start of reception to the moving image reproduction software. Moreover, the access software transmits a transmission request for an encoding stream of reproduction target segment data to the web server according to a command from the control software.

Furthermore, the access software receives segment data of a bit rate corresponding to a communication environment or the like, transmitted from the web server according to the transmission request. Then, the access software extracts an encoding stream from the received segment data and supplies the encoding stream to the moving image reproduction software.

<Configuration Example of Client Apparatus>

Next, a more detailed embodiment to which the present technology is applied will be described.

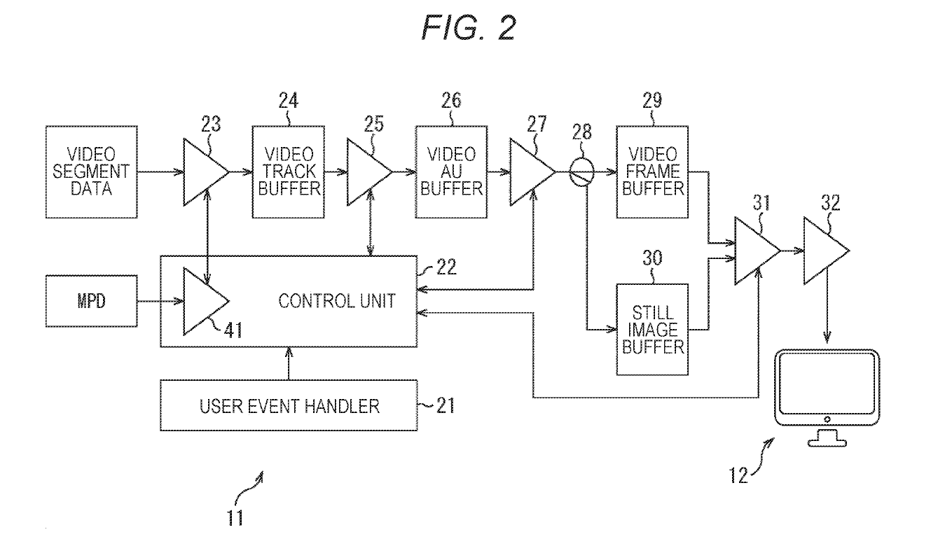

FIG. 2 is a diagram illustrating a configuration example of an embodiment of a client apparatus to which the present technology is applied.

A client apparatus 11 illustrated in FIG. 2 is a reproduction device and receives data (that is, moving image data) of contents from a server via a network, performs a process such as decoding or the like on the moving image data, and supplies the obtained moving image data to a display device 12 so that the moving image data is displayed.

In the client apparatus 11, the moving image data of contents is basically handled in a prescribed time unit (that is, in units of prescribed number of frames) called a segment in downloading, the subsequent process, and the like.

The client apparatus 11 includes a user event handler 21, a control unit 22, a downloader 23, a video track buffer 24, a MP4 parser 25, a video access unit (AU) buffer 26, a video decoder 27, a switch 28, a video frame buffer 29, a still image buffer 30, a video cross-fader 31, and a video renderer 32.

The user event handler 21 supplies a signal corresponding to a user's operation such as, for example, an adaptation set switching operation to the control unit 22.

The control unit 22 corresponds to the control software and acquires the MPD file from the server and controls respective units of the client apparatus 11 on the basis of the acquired MPD file.

Moreover, the control unit 22 has an MPD parser 41. The MPD parser 41 downloads the MPD file from the server, parses (analyzes) the MPD file, and acquires segment information from the MPD file. Moreover, the MPD parser 41 controls the downloader 23 on the basis of the acquired segment information so that video segment data (segment data) in which moving image data of contents is stored is acquired.

The downloader 23 corresponds to the access software and downloads video segment data from the server according to the control of the MPD parser 41. Moreover, the downloader 23 supplies the downloaded video segment data to the video track buffer 24 so that the video segment data is stored temporarily.

Note that the video segment data may be acquired from a recording medium or the like without limiting to a device on a network such as a server.

The video track buffer 24 is configured as a memory or the like, temporarily stores the video segment data supplied from the downloader 23 and supplies the stored video segment data to the MP4 parser 25.

The MP4 parser 25 reads the video segment data from the video track buffer 24, splits the video segment data into a prescribed unit of data called a video AU, and supplies the split data to the video AU buffer 26.

The video AU buffer 26 is configured as a memory or the like and temporarily stores the video AU supplied from the MP4 parser 25, and supplies the stored video AU to the video decoder 27.

The video decoder 27 reads the video AU from the video AU buffer 26, decodes the video AU, and supplies the moving image data (more specifically frames of a moving image (hereinafter also referred to as video frames)) obtained by the decoding to the video frame buffer 29 via the switch 28. Moreover, in a case where there is an instruction from the control unit 22, the video decoder 27 supplies a last video frame of the video segment data (that is, the last video frame of a segment) to the still image buffer 30 via the switch 28 as the last frame.

The switch 28 switches the output destination of the video frame supplied from the video decoder 27. That is, the switch 28 supplies the video frame supplied from the video decoder 27 to the video frame buffer 29 or the still image buffer 30.

The video frame buffer 29 is a storage unit including a memory or the like, stores the video frame supplied from the video decoder 27 via the switch 28, and supplies the stored video frame to the video cross-fader 31. Basically, all pieces of moving image data (the video frames of a moving image) obtained by the decoding by the video decoder 27 are supplied to and stored in the video frame buffer 29.

The still image buffer 30 is a storage unit including a memory or the like, stores the last frame supplied from the video decoder 27 via the switch 28, and supplies the stored last frame to the video cross-fader 31.

The video cross-fader 31 performs a video transition effect process of applying a video transition effect on the basis of the last frame stored in the still image buffer 30 and the video frame stored in the video frame buffer 29 and supplies the frames of the moving image data of the obtained transition moving image to the video renderer 32. In this case, the video cross-fader 31 functions as a moving image generating unit that generates moving image data of a transition moving image.

Moreover, the video cross-fader 31 supplies the video frame stored in the video frame buffer 29 to the video renderer 32 as it is in a period in which a video transition effect is not executed.

The video renderer 32 supplies the frames of the moving image data supplied from the video cross-fader 31 to an external display device 12 so that the moving image data frame is displayed.

In the client apparatus 11, the video track buffer 24 to the video renderer 32 correspond to the moving image reproduction software.

<Description of Streaming Reproduction Process>

Next, an operation of the client apparatus 11 will be described.

The control unit 22 of the client apparatus 11 controls the downloader 23 so that video segment data of a representation selected by a user or the like is downloaded for an adaptation set designated by the user or the like. Then, the control unit 22 reproduces the moving image stream of contents on the basis of the obtained video segment data.

In a case where contents is reproduced, an adaptation set is selected by a user, for example, and one appropriate representation is selected by the control unit 22 among a plurality of representations prepared for the selected adaptation set. Then, after that, the representations are switched by the control unit 22 appropriately according to a network bandwidth or the like.

During streaming reproduction of contents, at least the following five pieces of data are stored in the client apparatus 11.

(1) Last frame

(2) Video frame width

(3) Video frame height

(4) Video format

(5) Effect starting time point is

Here, the last frame is a last frame in time of a segment (that is, the last video sample in time), a pixel value of the last frame after decoding of moving image data is copied as it is and is stored in the still image buffer 30. Particularly, in this example, basically, it is controlled so that the last frame of each segment is surely stored in the still image buffer 30.

A video frame width and a video frame height are information indicating a horizontal length (number of pixels) and a vertical length (number of pixels) indicating the size (number of pixels) of the video frame. Furthermore, a video format is a control value indicating the format of a moving image reproduced on the basis of video segment data such as 4:2:0 YUV, for example.

The video frame width, the video frame height, and the video format are extracted from the MPD file by the control unit 22 and are appropriately supplied to the video decoder 27, the video cross-fader 31, and the like.

The effect starting time point ts is information indicating a starting time point of an effect period, a display time point (msec) of a video frame presented (displayed) at the start of the effect period is an effect starting time point ts. Note that, basically, the effect starting time point ts is a display time point of the starting video frame of a segment, and the effect starting time point ts is managed by the control unit 22.

For example, a composition time stamp (CTS) of a video frame included in the video segment data is used as the display time point of a video frame. The MP4 parser 25, the video decoder 27, and the video cross-fader 31 can refer to the display time point (CTS) correlated with each video frame. In the following description, a display time point of a processing target video frame will be referred to as a display time point t.

Furthermore, in the client apparatus 11, an effect period length d (msec) indicating the length of an effect period is set in advance, and the effect period length d is managed by the control unit 22. For example, the effect period length d may be a predetermined length and may be a length designated by a user or the like and may be a length determined in advance for contents.

For example, in a case where information indicating the time to be used as the effect period length d can be stored in an MPD file, a contents provider can designate the effect period length d.

The effect period length d may be a length that exceeds the length of a segment (that is, a reproduction length of one video segment).

Furthermore, in the control unit 22, a scene change detection flag indicating a detection result of a scene change of contents (that is, a detection result of change to a representation of a different adaptation set) is managed.

The scene change detection flag is information indicating whether or not switching of representations such that a scene change occurs (that is, transition to another representation) has occurred.

For example, in a case where switching (transition) of representations results from switching of adaptation sets, that is, in a case where switching to a representation of another adaptation set different from the adaptation set at the present viewpoint occurs, the value of the scene change detection flag is set to “1”.

It is assumed that a moving image of a representation of a prescribed adaptation set at the present viewpoint is reproduced, and an instruction to switch reproduction moving images (a display switching instruction) is issued so that a moving image of a representation of another adaptation set is reproduced.

In this case, since the moving image before switching and the moving image after switching display different images (videos) and a scene change occurs, it is necessary to execute a video transition effect so that disharmony does not occur during switching the display.

In contrast, for example, in a case where switching of representations is switching to a different representation in the same adaptation set, that is, representations before and after switching are different but adaptation sets do not change, the value of the scene change detection flag is set to “0”.

This is because, even when a prescribed representation prepared for the same adaptation set is switched to another representation, the image quality or the like changes before and after the switching but the video itself does not change, a scene change does not occur, and it is not necessary to execute a video transition effect particularly.

The control unit 22 updates the value of the scene change detection flag stored therein appropriately on the basis of a signal supplied from the user event handler 21.

Next, a specific process performed by the client apparatus 11 will be described.

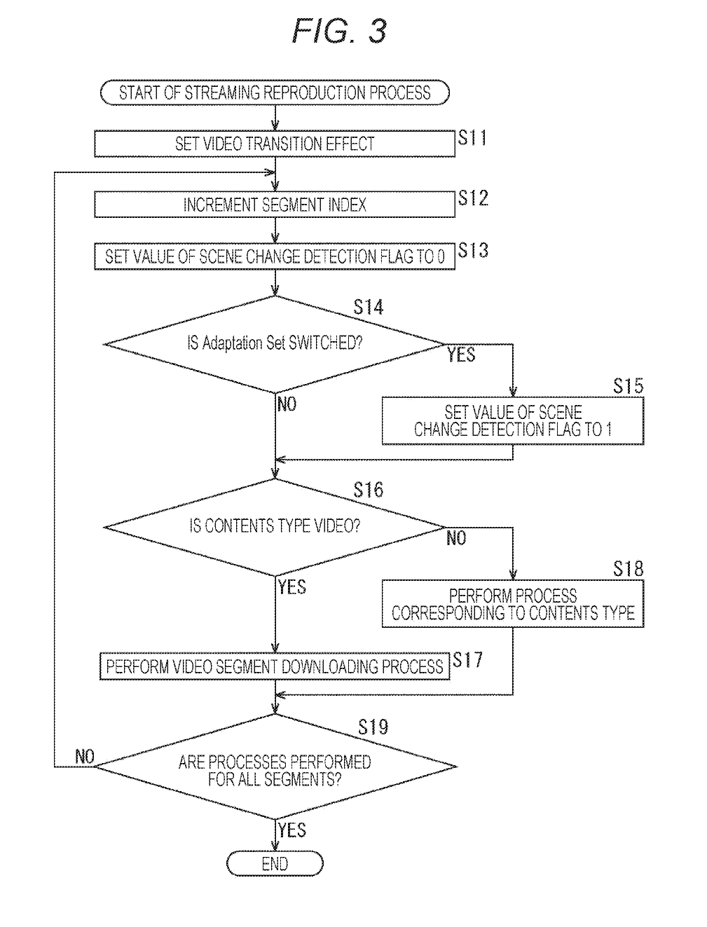

That is, hereinafter, a streaming reproduction process performed by the client apparatus 11 will be described with reference to the flowchart of FIG. 3. The streaming reproduction process starts when an adaptation set of contents is designated by a user.

In step S11, the control unit 22 performs initial setting of a video transition effect.

For example, the control unit 22 sets a predetermined value, a value designated in an MPD file, or the like as the value of the effect period length d and sets the value of the effect starting time point is to −1.

The effect period length d and the value of the effect starting time point is are integer values in millisecond units, for example, and in a case where these values are 0 or a negative value, a video transition effect is not executed.

Moreover, the control unit 22 sets the value of a segment index for identifying a processing target segment (that is, segment data to be downloaded) to 0.

In addition to this, in the control unit 22, a video frame width, a video frame height, a video format, and the like are read from the MPD file and are stored in advance.

In step S12, the control unit 22 increments the value of the segment index stored therein by 1.

In step S13, the control unit 22 sets the value of the scene change detection flag stored therein to 0.

In step S14, the control unit 22 determines whether or not switching (transition) of an adaptation set is present on the basis of a signal supplied from the user event handler 21.

In a case where it is determined in step S14 that switching of an adaptation set is present, the control unit 22 sets the value of the scene change detection flag stored there to 1 in step S15. In this way, it is understood that a scene change has occurred in a processing target segment.

For example, in the MP4 parser 25 and the video decoder 27, a timing at which video segment data stored in the video track buffer 24 is downloaded is not clear. Due to this, it is difficult for the MP4 parser 25 and the video decoder 27 to accurately identify the timing at which the adaptation set was switched.

Therefore, in the client apparatus 11, the control unit 22 sets the value of the scene change detection flag on the basis of the signal supplied from the user event handler 21 and the MP4 parser 25 and the video decoder 27 can identify a switching timing of the adaptation set from the scene change detection flag.

The value of the scene change detection flag is set to 1 when switching of a representation occurs due to switching of an adaptation set only, and in other cases, is set to 0. By doing so, it is possible to determine whether it is necessary to execute a video transition effect from the scene change detection flag.

When the scene change detection flag is updated to 1, the flow proceeds to step S16.

In contrast, in a case where it is determined in step S14 that switching of an adaptation set is not present, the flow proceeds to step S16.

When it is determined in step S14 that switching of an adaptation set is not present or when the scene change detection flag is updated in step S15, the control unit 22 determines whether or not a contents type of a processing target segment is video in step S16.

In a case where it is determined in step S16 that the contents type is video, the client apparatus 11 performs a video segment downloading process in step S17.

Note that, in the video segment downloading process which will be described in detail later, the control unit 22 instructs the downloader 23 to download video segment data of a processing target segment, and the downloader 23 downloads the video segment data according to the instruction. Moreover, a moving image is reproduced on the basis of the downloaded video segment data.

When the video segment downloading process is performed, the flow proceeds to step S19.

In contrast, in a case where it is determined in step S16 that the contents type is not video, the client apparatus 11 performs a process corresponding to the contents type in step S18 and the flow proceeds to step S19.

For example, in a case where the contents type is audio, the client apparatus 11 downloads segment data of an audio and reproduces the audio on the basis of the obtained segment data in step S18.

When the video segment downloading process is performed in step S17 or the process corresponding to the contents type is performed in step S18, the control unit 22 determines whether or not the process has been performed for all segments in step S19.

In a case where it is determined in step S19 that the process has not been performed for all segments (that is, there is a segment to be process), the flow returns to step S12, and the above-described process is performed repeatedly.

In contrast, in a case where it is determined in step S19 that the process has been performed for all segments, since reproduction of contents has ended, the streaming reproduction process ends.

In this manner, the client apparatus 11 downloads video segment data and the like to reproduce a moving image and the like and sets the value of the scene change detection flag to 1 when switching of an adaptation set has occurred.

<Description of Video Segment Downloading Process>

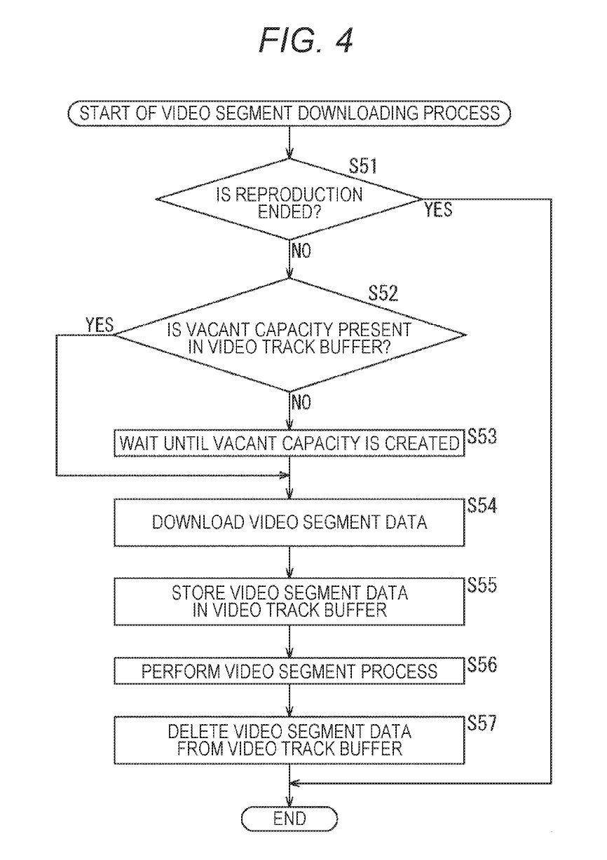

Subsequently, a video segment downloading process performed by the client apparatus 11 in correspondence to the process of step S17 in FIG. 3 will be described with reference to the flowchart of FIG. 4.

In step S51, the control unit 22 determines whether or not reproduction of contents has ended on the basis of the MPD file obtained by the MPD parser 41. For example, it is determined that reproduction of contents has ended in a case where the value of the segment index is larger than the value of a segment index of the last segment of the contents.

In a case where it is determined in step S51 that reproduction of contents has ended, since there is no video segment data to be downloaded, the video segment downloading process ends. In this case, it is determined that the process of step S19 in FIG. 3 performed subsequently has been performed for all segments.

In contrast, in a case where it is determined in step S51 that reproduction has not ended (that is, there is remaining video segment data to be downloaded), the control unit 22 instructs the downloader 23 to download the video segment data to be downloaded and the flow proceeds to step S52.

In step S52, the downloader 23 determines whether or not there is a vacant capacity in which new video segment data can be stored is present in the video track buffer 24.

In a case where it is determined in step S52 that there is a vacant capacity, the flow proceeds to step S54.

In contrast, in a case where it is determined in step S52 that there is no vacant capacity, the downloader 23 waits without downloading the video segment data designated by the control unit 22 until a sufficient vacant capacity is created in the video track buffer 24 in step S53.

Then, when a sufficient vacant capacity is created in the video track buffer 24, the flow proceeds to step S54.

When it is determined in step S52 that there is a vacant capacity or when the downloader 23 waits in step S53, the downloader 23 downloads the video segment data designated by the control unit 22 from the server in step S54. That is, the downloader 23 receives the video segment data transmitted from the server.

In step S55, the downloader 23 supplies the downloaded video segment data to the video track buffer 24 so that the video segment data is stored therein.

In step S56, the client apparatus 11 performs a video segment process. Note that, in the video segment process which will be described in detail later, the video segment data stored in the video track buffer 24 is read and parsed by the MP4 parser 25, the video segment data is downloaded, and a video transition effect is applied to the moving image data.

In step S57, the MP4 parser 25 deletes the video segment data processed in step S56 from the video track buffer 24. That is, the processed video segment data is discarded.

When the process of step S57 is performed and the unnecessary video segment data is discarded, the video segment downloading process ends.

In this manner, the client apparatus 11 downloads and processes the video segment data sequentially.

<Description of Video Segment Process>

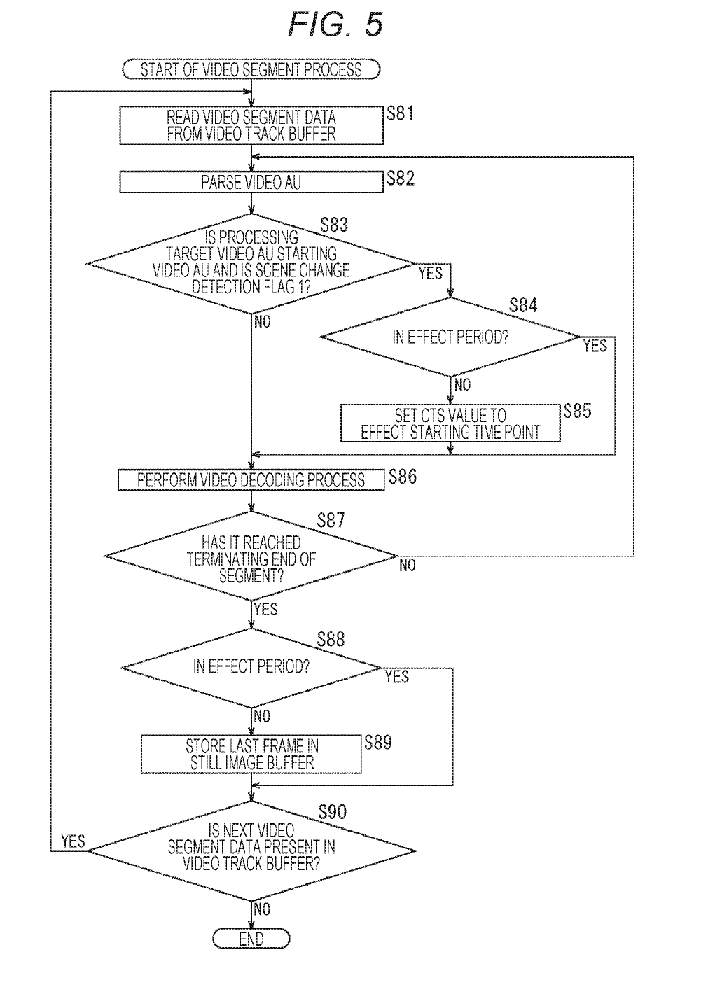

Moreover, the video segment process performed by the client apparatus 11 in correspondence to the process of step S56 in FIG. 4 will be described with reference to the flowchart of FIG. 5.

In step S81, the MP4 parser 25 reads one segment of video segment data from the video track buffer 24.

In step S82, the MP4 parser 25 parses a video AU.

That is, the MP4 parser 25 selects a video AU that forms the video segment data read in the process of step S81 sequentially as a processing target video AU.

The MP4 parser 25 parses the processing target video AU and supplies the processing target video AU to the video AU buffer 26 so that the video AU is stored therein. Note that one video AU is one frame of data of a moving image.

In step S83, the MP4 parser 25 determines whether or not the processing target video AU is a starting video AU of the video segment data and the value of the scene change detection flag stored in the control unit 22 is 1.

For example, in the MPEG-DASH streaming reproduction, since the switching timing of a representation is the starting timing of a segment, there is a possibility that the video AU at the start of a segment is the timing at which a scene change occurs (that is, the starting time point of an effect period).

In a case where it is determined in step S83 that the processing target video AU is not the starting video AU or the value of the scene change detection flag is not 1, the flow proceeds to step S86.

In contrast, in a case where it is determined in step S83 that the processing target video AU is the starting video AU and the value of the scene change detection flag is 1, the flow proceeds to step S84.

In step S84, the MP4 parser 25 determines whether or not the video frame is in the effect period on the basis of the display time point t of the processing target video AU (that is, the display time point t of the video frame corresponding to the video AU) and the effect starting time point ts and the effect period length d stored in the control unit 22.

For example, when the video transition effect is executed under the following conditions, it is possible to prevent failure of the video transition effect even if the effect period length exceeds the segment length.

That is, in a case where 0≤ts, ts≤t, and t≤ts+d, it may be determined that the video frame of the display time point t is a video frame in the effect period.

Therefore, in step S84, for example, in a case where the effect starting time point ts is 0 or more, the display time point t is the effect starting time point ts or more, and the display time point t is equal to or smaller than the sum of the effect starting time point ts and the effect period length d, it is determined that the video frame is in the effect period.

In a case where it is determined in step S84 that the video frame is not in the effect period, the MP4 parser 25 sets the display time point t of the video AU used as a processing target in step S82 (that is, the value of CTS of the processing target video AU) to the effect starting time point ts in step S85. That is, the value of the CTS of the processing target video AU is substituted into the effect starting time point ts.

In this way the display time point correlated with the starting video AU of the segment at a timing at which switching of a representation including switching (transition) of an adaptation set occurs is used as a new effect starting time point ts. Such a video AU is the starting video AU of the first segment of a switching destination adaptation set.

Note that, in the client apparatus 11, although the effect starting time point ts is not particularly limited, generally, a series of scenes are recorded in one segment or an edited version is recorded even if a scene change is included. Therefore, it is exceptional to set an intermediate time point of a schematic diagram to the effect starting time point ts.

When the effect starting time point ts is set in this manner, the effect starting time point ts is supplied to the control unit 22, and the flow proceeds to step S86.

On the other hand, in a case where it is determined in step S84 that the video frame is in the effect period, since the effect starting time point is is determined in advance, the process of step S85 is not performed, and the flow proceeds to step S86.

In a case where it is determined in step S83 that the processing target video AU is not the starting video AU or the value of the scene change detection flag is not 1, in a case where the process of step S85 is performed, or in a case where it is determined in step S84 that the video frame is in the effect period, the process of step S86 is performed.

In step S86, the client apparatus 11 performs a video decoding process to decode the processing target video AU stored in the video AU buffer 26. Note that the details of the video decoding process will be described later.

In step S87, the MP4 parser 25 determines whether or not the terminating end of a segment has been reached. For example, in a case where the processing target video AU is the last video AU of a segment (that is, the video segment data), it is determined that the template group of the segment has been reached.

In a case where it is determined in step S87 that the terminating end of the segment has not been reached, since decoding of the video segment data read in step S81 is not ended, the flow returns to step S82 and the above-described process is performed repeatedly.

In contrast, in a case where it is determined in step S87 that the terminating end of the segment has been reached, the video decoder 27 determines whether or not the video frame is in the effect period in step S88. In step S88, the display time point t of the video AU input to the video decoder 27 is used and a process similar to the case of step S84 is performed.

In a case where it is determined in step S88 that the video frame is not in the effect period, the video decoder 27 supplies the last frame of the segment obtained in the process of step S86 to the still image buffer 30 via the switch 28 so that the last frame is stored therein in step S89.

In this case, the video decoder 27 secures a recording area necessary for storing the last frame in the still image buffer 30 on the basis of the video frame width, the video frame height, and the video format stored in the control unit 22.

For example, the size of the recording area necessary for storing the last frame is determined by the video frame width, the video frame height, and the video format, and the size of the recording area can be determined at the timing of the reproduction starting time point of each segment.

Specifically, for example, it is assumed that the video frame width is 3840 pixels and the video frame height is 2160 pixels. Moreover, it is assumed that the video format is a 4:2:0 YUV format (that is, a format in which the U-signal among square 2×2 pixels is taken from one pixel of the upper two pixels and the V-signal is taken from one pixel of the lower two pixels.

In such a case, a recording area of 12441600 bytes (=3840×2160×3/2) may be secured as an area for storing the last frame.

By the above-described process, in the client apparatus 11, for all segments in which the terminating end portion is not included in the effect period (that is, segments which can be used for the video transition effect as a transition source segment), a video frame that is the last in time of a segment is necessarily stored in the still image buffer 30 as the last frame. Therefore, even when transition to the next representation occurs in the next segment of the segment, it is possible to execute a video transition effect immediately using the video segment data subsequent to the next segment and the last frame stored in the still image buffer 30.

When the last frame is stored in the still image buffer 30, the flow proceeds to step S90.

On the other hand, in a case where it is determined in step S88 that the video frame is in the effect period, since the last frame included in the effect period is not used for a video transition effect, the process of step S89 is not executed and the flow proceeds to step S90.

When it is determined in step S88 that the video frame is in the effect period or the process of step S89 is performed, the process of step S90 is performed.

In step S90, the MP4 parser 25 determines whether or not the next video segment data of the video segment data read in step S81 is present in the video track buffer 24.

In a case where it is determined in step S90 that the next video segment data is present, the flow returns to step S81 and the above-described process is performed repeatedly.

In contrast, in a case where it is determined in step S90 that the next video segment data is not present, the video segment process ends.

In this manner, the client apparatus 11 stores the last video frame of a segment in which the terminating end portion is not included in the effect period in the still image buffer 30 as the frame for the video transition effect. In this way, it is possible to execute a video transition effect more easily (that is, with a smaller number of processes) using the video frame (the last frame) stored in the still image buffer 30 and to suppress disharmony during switching of display.

<Description of Video Decoding Process>

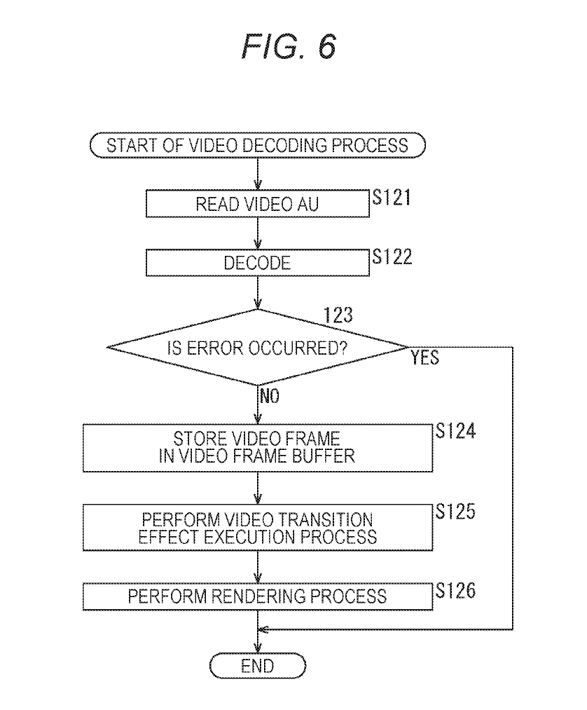

Furthermore, a video decoding process performed by the client apparatus 11 in correspondence to the process of step S86 in FIG. 5 will be described with reference to the flowchart of FIG. 6.

In step S121, the video decoder 27 reads one video AU from the video AU buffer 26. Then, in step S122, the video decoder 27 decodes the read video AU.

In step S123, the video decoder 27 determines whether or not an error has occurred in the decoding of step S122.

In a case where it is determined in step S123 that an error has occurred, the video decoding process ends.

In contrast, in a case where it is determined in step S123 that an error has not occurred, the video decoder 27 supplies the video frame obtained as the result of decoding to the video frame buffer 29 via the switch 28 so that the video frame is stored therein in step S124.

In this case, the video decoder 27 secures the recording area necessary for the video frame buffer 29 on the basis of the video frame width, the video frame height, and the video format stored in the control unit 22.

In step S125, the video cross-fader 31 performs a video transition effect execution process, generates a presentation (display) video frame as one frame of data of the moving image data, and supplies the data to the video renderer 32.

Note that, in the video transition effect execution process which will be described in detail later, the presentation video frame is generated on the basis of the video frame stored in the video frame buffer 29 and the last frame stored in the still image buffer 30 as necessary.

In step S126, the video renderer 32 performs a rendering process on the presentation video frame supplied from the video cross-fader 31 and supplies the obtained video frame (that is, moving image data) to the display device 12 so that the moving image is displayed.

When the moving image data is supplied to the display device 12, the video decoding process ends. Note that the video decoding process is performed for each video AU until there is no video AU stored in the video AU buffer 26.

In this manner, the client apparatus 11 decodes the video segment data in units of video AUs and performs a video transition effect as necessary.

<Description of Video Transition Effect Execution Process>

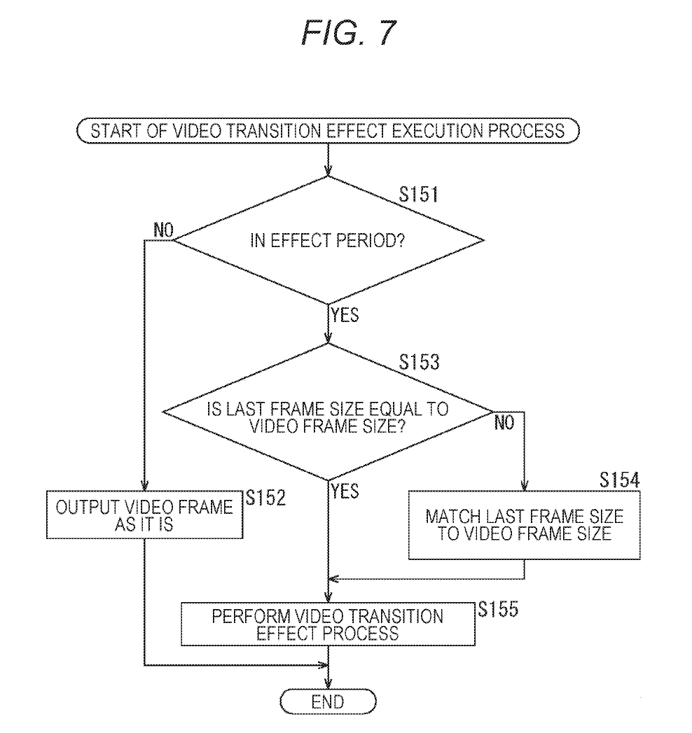

Next, a video transition effect execution process performed by the video cross-fader 31 in correspondence to the process of step S125 in FIG. 6 will be described with reference to the flowchart of FIG. 7. For example, the video transition effect execution process is performed for each video frame.

In step S151, the video cross-fader 31 determines whether or not the video frame is in the effect period on the basis of the display time point t of the video frame stored in the video frame buffer 29 and the effect starting time point is and the effect period length d stored in the control unit 22. In step S151, a process similar to that of step S84 in FIG. 5 is performed.

In a case where it is determined in step S151 that the video frame is not in the effect period, the process of step S152 is performed.

In step S152, the video cross-fader 31 outputs the video frame stored in the video frame buffer 29 to the video renderer 32 as a presentation video frame as it is and the video transition effect execution process ends.

In a case where the video frame is not in the effect period, since it is not necessary to apply a video transition effect to the video frame stored in the video frame buffer 29 particularly, the video frame is output as the presentation video frame as it is.

Note that, more specifically, although the size (that is, the width and the height) of the video frame is determined for each representation, the video cross-fader 31 converts the size of the video frame to a predetermined size as necessary and then outputs the video frame.

In contrast, in a case where it is determined in step S151 that the video frame is in the effect period, the flow proceeds to step S153.

In step S153, the video cross-fader 31 determines whether or not the size of the last frame which is the still image stored in the still image buffer 30 is the same as the size of the video frame which is a moving image stored in the video frame buffer 29.

In a case where it is determined in step S153 that the size is the same, the video cross-fader 31 reads the last frame from the still image buffer 30 and reads the video frame from the video frame buffer 29 and the flow proceeds to step S155.

In contrast, in a case where it is determined in step S153 that the size is not the same, the video cross-fader 31 reads the last frame from the still image buffer 30 and reads the video frame from the video frame buffer 29 and the flow proceeds to step S154.

In step S154, the video cross-fader 31 performs a size conversion process on the read last frame so that the size of the last frame matches the size of the video frame read from the video frame buffer 29. That is, a resize process (a size conversion process) is performed so that the last frame and the video frame have the same size.

When the size of the last frame matches the size of the video frame, the flow proceeds to step S155.

When the process of step S154 is performed or when it is determined in step S153 that the size is the same, the video cross-fader 31 performs a video transition effect process on the basis of the last frame and the video frame in step S155.

In this way, a video transition effect is performed and the frame of the transition moving image is obtained as the presentation video frame. In this case, the frame that is the last in time of the last segment before switching (that is, transition) of the display (viewpoint) is used as the last frame and the frame (moving image data) of the transition moving image is generated.

The video cross-fader 31 supplies the presentation video frame obtained by the video transition effect process to the video renderer 32 and the video transition effect execution process ends.

For example, the video cross-fader 31 performs a cross-fade process, a wipe process, or the like as the video transition effect process.

Specifically, for example, in a case where cross-fade (that is, dissolve using alpha blending) is performed as the video transition effect process, a video frame which is a fade-in-side frame and a last frame which is a fade-out-side frame are blended by a prescribed alpha value whereby a presentation video frame is generated. That is, a video frame and a last frame are combined by a prescribed combination ratio (a mixing ratio) whereby a presentation video frame is obtained.

Here, an alpha value indicates a blending ratio (a mixing ratio) of a video frame and a last frame, and the alpha value of the fade-out-side frame is α, for example.

In this case, the alpha value a changes linearly or non-linearly from 100% to 0% according to the display time point t of the fade-in-side video frame (that is, a time point within the effect period).

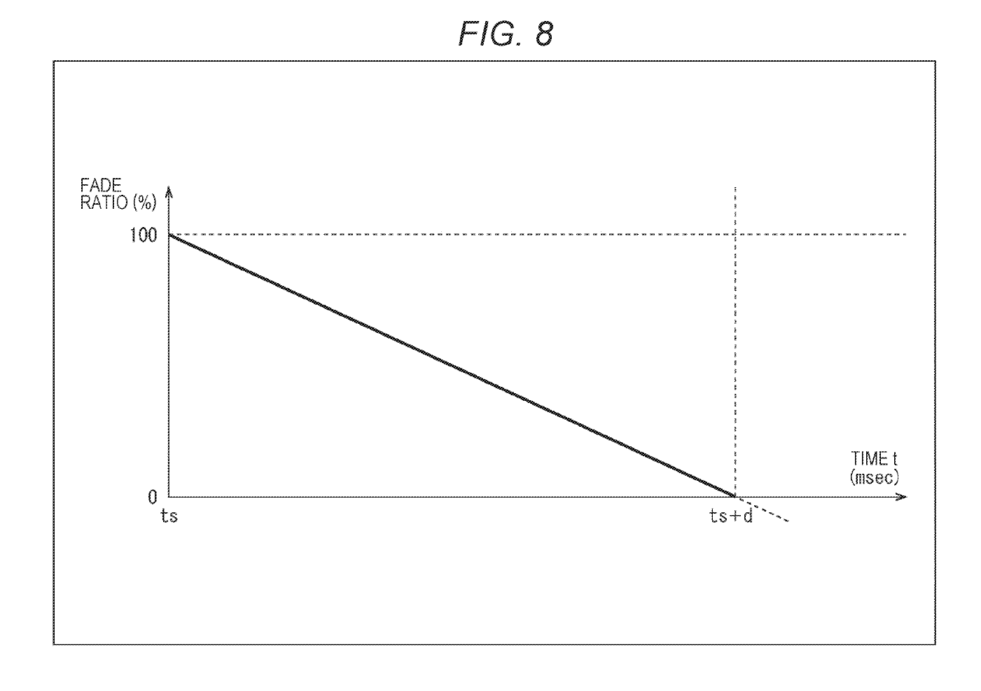

For example, as illustrated in FIG. 8, the alpha value α may decrease linearly from the effect starting time point ts to an ending time point ts+d of the effect period. Note that, in FIG. 8, the vertical axis indicates an alpha value α (that is, a fade ratio (a blending ratio)), and the horizontal axis indicates a display time point t of the video frame (that is, a display time point of the presentation video frame).

In this example, the alpha value α is 100% at the effect starting time point ts and is 0% at the ending time point ts+d of the effect period, and the alpha value α decreases monotonously at the intermediate time point. That is, the alpha value α at the display time point t has a value obtained by α=100×(d−t+ts)/d. In this case, the blending ratio of the fade-in-side frame increases linearly (monotonously) from 0% to 100% in the period between the effect starting time point ts and the ending time point ts+d of the effect period.

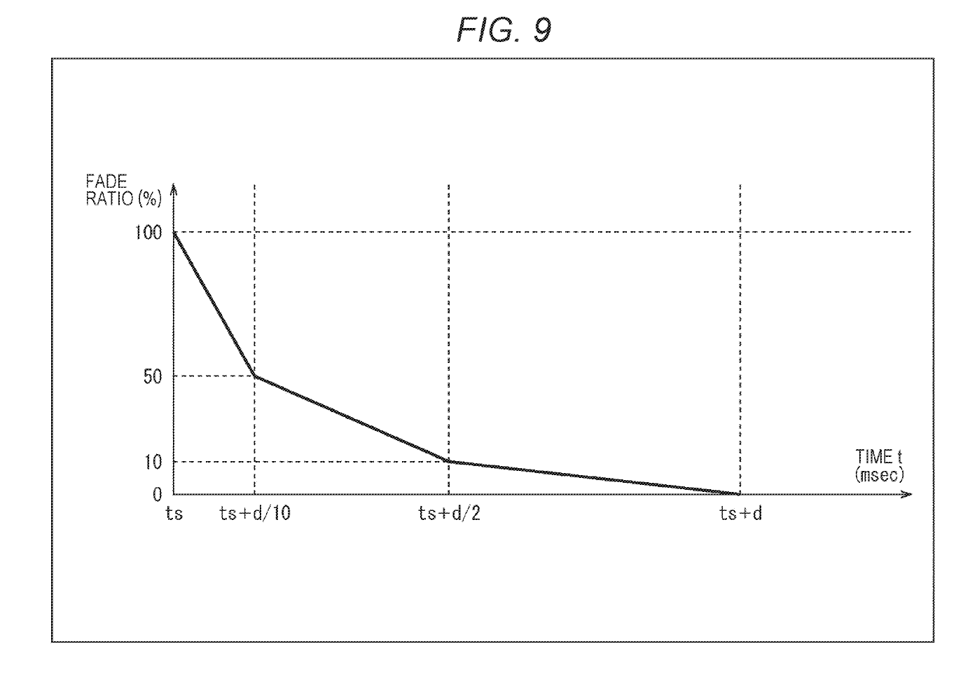

In addition to this, a plurality of linear functions may be combined so that the alpha value α changes non-linearly as illustrated in FIG. 9, for example. Note that, in FIG. 9, the vertical axis indicates the alpha value α (that is, the fade ratio), and the horizontal axis indicates the display time point t of the video frame (that is, the display time point of the presentation video frame).

In this example, the alpha value α changes non-linearly with time, and the slope indicating the change in the alpha value α changes gradually with time.

In this example, in the period between the effect starting time point ts and the time point (ts+d/10), the alpha value α has a value obtained by α=100−5×100(t−ts)/d.

Moreover, in the period between the time point (ts+d/10) and the time point (ts+d/2), the alpha value a has a value obtained by α=60−100 (t−ts)/d. In the period between the time point (ts+d/2) and the ending time point ts+d, the alpha value a has a value obtained by α=20−100(t−ts)/5d.

Therefore, in this example, during display switching (that is, in the effect period), a fade-out-side frame (a transition source image) disappears abruptly, and a fade-in-side frame (a transition destination image) appears abruptly. In other words, moving image data of a transition moving image in which the display transitions from a transition source image to a transition destination image more abruptly on the starting side of the effect period than the ending side of the effect period is generated.

In the video transition effect of the video cross-fader 31, the fade-out-side frame is a still image (the last frame) and the frame is fixed. Due to this, in a case where the alpha value α of the last frame changes linearly, since the pattern of the fade-out-side frame is fixed, the last frame is likely to remain in the visual perception of a viewing user.

Therefore, by determining the alpha value α so that the last frame disappears abruptly as in the example illustrated in FIG. 9, it is possible to further suppress disharmony during switching of display.

As described above, the video cross-fader 31 applies a video transition effect to a switching portion of a moving image on the basis of the last frame which is a still image and the video frame which is a moving image. In this way, it is possible to suppress disharmony during switching of moving images more easily.

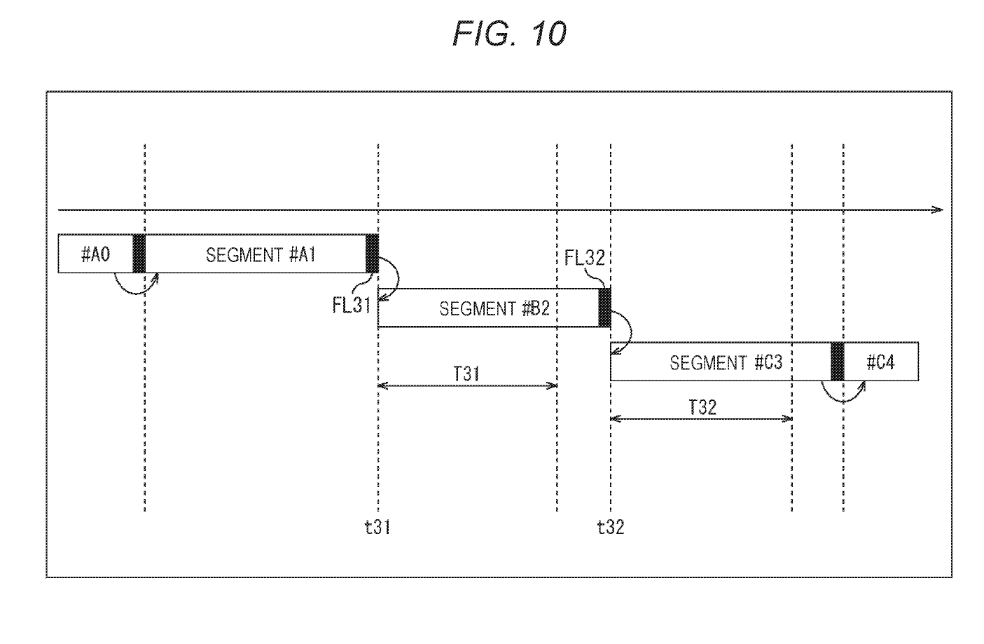

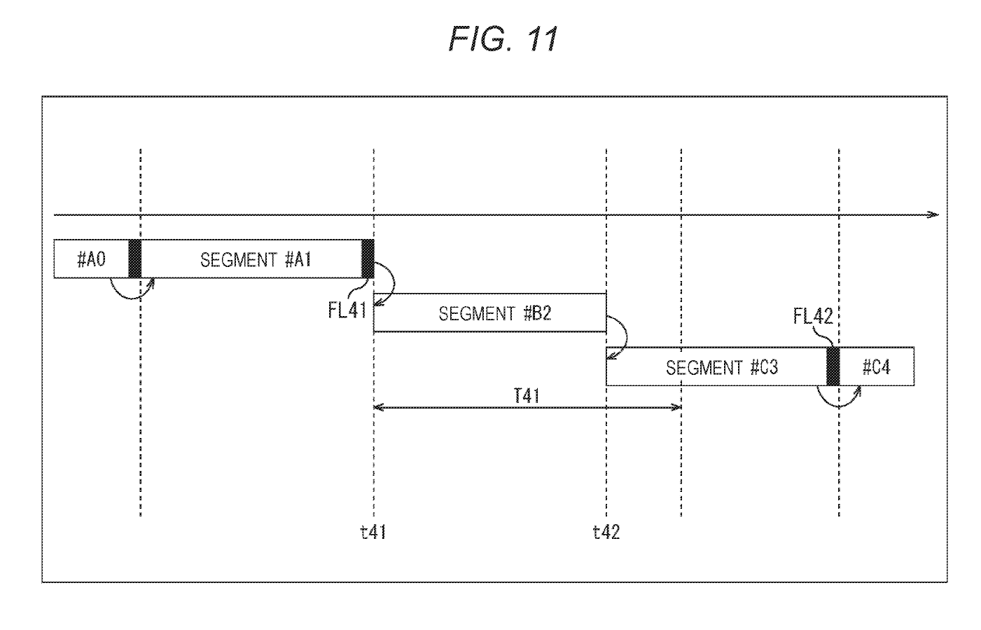

In the client apparatus 11, display switching and the video transition effect are executed as illustrated in FIGS. 10 and 11, for example, so that the last video frame of a segment is stored in the still image buffer 30 as a last frame in a period other than the effect period.

For example, in FIG. 10, first, video segment data of Segment#A0 and Segment#A1 of a prescribed representation is downloaded to reproduce contents, and the last video frame of these segments is used as the last frame.

In this example, the last video frame of Segment#A1, for example, is stored in the still image buffer 30 as the last frame FL31.

After that, when switching of representations including transition of adaptation sets occurs at time point t31, video segment data of Segment#B2 of a representation different from the preceding representations is downloaded, and display switching and a video transition effect are executed.

That is, in this example, time point t31 is used as an effect starting time point, a period T31 is used as an effect period, and in this effect period, and a presentation video frame is generated and displayed by a video transition effect process using the last frame FL31 and the video frame of each time point of Segment#B2.

Particularly, in this example, the period T31 which is the effect period is set to a period having a length shorter than the segment length. When the effect period ends, the video frame of each time point of Segment#B2 is displayed as the presentation video frame as it is, and the last video frame of Segment#B2 is stored in the still image buffer 30 as the last frame FL32.

Furthermore, at time point t32, when switching of representations including transition of adaptation sets occur, video segment data of Segment#C3 of a representation different from the previous representations is downloaded, and display switching and a video transition effect are executed. That is, a period T32 having the same length as the period T31 in which time point t32 is an effect starting time point is used as the effect period, and a video transition effect process is executed in this effect period. In this case, the last frame FL32 is used during the video transition effect.

Moreover, in the example illustrated in FIG. 11, for example, first, video segment data of Segment#A0 and Segment#A1 is downloaded to reproduce contents. Moreover, for example, the last video frame of Segment#A1 is stored in the still image buffer 30 as a last frame FL41.

After that, when switching of representations including transition of adaptation sets occurs at time point t41, video segment data of Segment#B2 of a representation different from the preceding registers is downloaded, and display switching and a video transition effect are executed.

Moreover, switching of representations including transition of adaptation sets occurs at time point t42, the video segment data of Segment#C3 of a representation different from the preceding representations is downloaded, and display switching and a video transition effect are executed.

In this example, a period T41 which is an effect period is a period having a length longer than the segment length. That is, the effect period length d is longer than the segment length.

Therefore, in this example, in the period T41 including partial sections of Segment#B2 and Segment #C3, and a presentation video frame is generated and displayed using the last frame FL41 and the video frame of each time point of Segment#B2 and Segment#C3.

After that, when the effect period ends, the video frame of each time point of Segment#C3 is displayed as the presentation video frame as it is, and the last video frame of Segment#C3 is stored in the still image buffer 30 as the last frame FL42.

As illustrated in FIGS. 10 and 11, in the client apparatus 11, the effect period length d may be shorter or longer than the segment length, and in any case, it is possible to switch the display from a source moving image to a destination moving image smoothly.

As described above, according to the client apparatus 11, in moving image reproduction such as MPEG-DASH streaming reproduction, it is possible to execute a video transition effect without decoding two moving images simultaneously during scene change of moving image reproduction. In this way, it is possible to suppress disharmony during switching of moving images easily with a smaller number of processes.

Particularly, since the last video frame of each segment is always stored in the still image buffer 30 in a period other than a video transition effect execution period, it is possible to execute a video transition effect appropriately regardless of the reliability of the value of the scene change detection flag.

### Second Embodiment

<Description of Video Segment Process>

However, in the above-described example, in a period other than the effect period, the last video frame of a segment is always stored in the still image buffer 30 as a last frame. However, in such a case, some of the last frame stored in the still image buffer 30 may be discarded without being used for the video transition effect, which is a waste of storage capacity.

Therefore, an unnecessary video frame may be prevented from being stored as the last frame using an input-to-output delay of the video decoder 27 so that the processing load of the client apparatus 11 is decreased.

In this example, an input-to-output time difference (delay) unique to the video decoder 27 is used. That is, a video frame output from the video decoder 27 at the timing at which the starting video AU of the starting segment after switching of representations including transition of adaptation sets is input to the video decoder 27 or immediately after the timing is stored in the still image buffer 30 as the last frame. In other words, the video frame output first from the video decoder 27 after the starting video AU of the segment after switching is input to the video decoder 27 is used as the last frame of the segment before the switching.

In the video decoder 27, rather than outputting a video frame corresponding to a video AU immediately after the video AU is input, a corresponding video frame is output after several other video AUs are input after the video AU is input. That is, a delay corresponding to several frames occurs from the input to the output.

As a specific example, for example, after a video AU of a first frame is input and decoding starts, video AUs of the second and third frames are input and decoding is performed successively, and the video frame of the first frame is output from the video decoder 27 at a timing at which a video AU of the fourth frame is input.

Such a processing delay of the video decoder 27 is different depending on the number of delayed video frames and the implementation of the video decoder 27 and results from an encoding scheme in which the delay occurs when the B-frame and the P-frame are reordered in MPEG video encoding. The processing delay occurs inevitably theoretically.

Generally, in the client apparatus 11 which is a reproduction device, it is easy to grasp a delay occurring in the video decoder 27 mounted therein in advance (that is, how many frames of delay occurs).

Therefore, a video frame output from the video decoder 27 at a timing at which a video AU of a frame later than a number of frames corresponding to the delay of the video decoder 27 from the starting frame, included in a segment immediately after the occurrence of switching of representations including a scene change (that is, transition of adaptation sets), for example, is input to the video decoder 27 may be used as the last frame. In other words, the first video frame output from the video decoder 27 after a video AU of a predetermined frame of a segment immediately after the occurrence of switching is input to the video decoder 27 is stored in the still image buffer 30.

In the following description, it is assumed that at a timing at which a video AU of a starting frame of a segment immediately after a scene change, for example, is input the video decoder 27, a video frame that is the last in time, of the previous segment is output from the video decoder 27, and the video frame is used as the last frame. That is, in this example, it is assumed that the delay occurring in the video decoder 27 is a period corresponding to one frame.

In a case where the last frame is stored using the processing delay occurring in the video decoder 27 in this manner, the client apparatus 11 performs the streaming reproduction process described with reference to FIG. 3. Then, in step S17 of the streaming reproduction process, the video segment downloading process described with reference to FIG. 4 is performed.

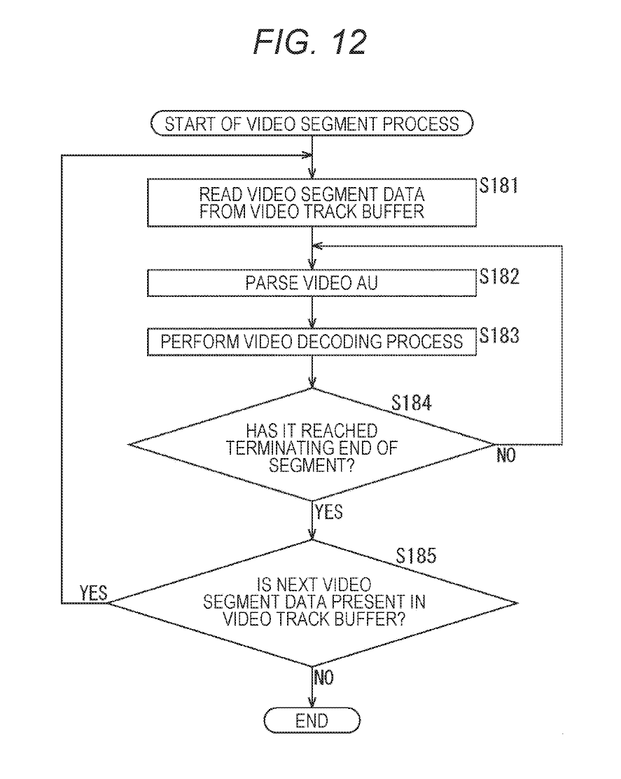

However, in step S56 of the video segment downloading process, the video segment process illustrated in FIG. 12 rather than the video segment process described with reference to FIG. 5 is performed.

Hereinafter, a video segment process performed by the client apparatus 11 in correspondence to the process of step S56 in FIG. 4 will be described with reference to the flowchart of FIG. 12. Note that the processes of steps S181 and S182 are similar to the processes of steps S81 and S82 in FIG. 5, and the description thereof will be omitted.

In step S183, the client apparatus 11 performs a video decoding process to decode a processing target video AU stored in the video AU buffer 26. Note that the details of the video decoding process will be described later.

In step S184, the MP4 parser 25 determines whether or not the terminating end of a segment has been reached. For example, in step S184, a process similar to that of step S87 in FIG. 5 is performed.

In a case where it is determined in step S184 that the terminating end of the segment has not been reached, since decoding of the video segment data read in step S181 is not ended, the flow returns to step S182 and the above-described process is performed repeatedly.

In contrast, in a case where it is determined in step S184 that the terminating end of the segment has been reached, the MP4 parser 25 determines whether or not video segment data subsequent to the video segment data read in step S181 is present in the video track buffer 24 in step S185.

In a case where it is determined in step S185 that the subsequent video segment data is present, the flow returns to step S181, and the above-described process is performed repeatedly.

In contrast, in a case where it is determined in step S185 that the subsequent video segment data is not present, the video segment process ends.

In this manner, the client apparatus 11 reads video segment data and video AUs sequentially and decodes the video segment data and the video AUs.

<Description of Video Decoding Process>

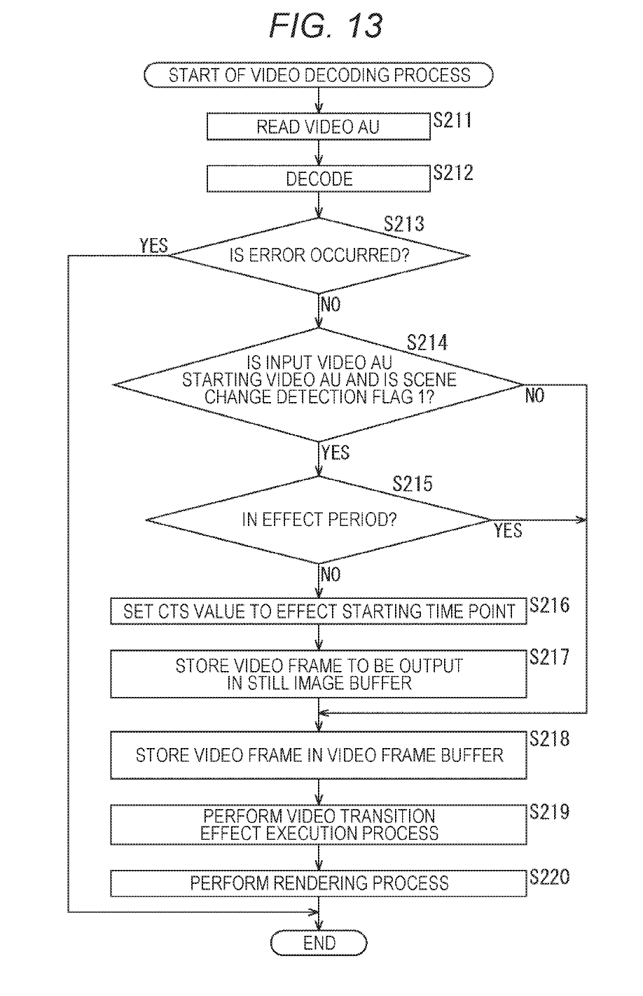

Furthermore, a video decoding process performed by the client apparatus 11 in correspondence to the process of step S183 in FIG. 12 will be described with reference to the flowchart of FIG. 13.

Note that the processes of steps S211 to S213 are similar to the processes of steps S121 to S123 in FIG. 6, and the description thereof will be omitted.

In a case where it is determined in step S213 that an error has occurred, the video decoding process ends. Moreover, in a case where it is determined in step S213 that an error has not occurred, the flow proceeds to step S214.

In step S214, the video decoder 27 determines whether or not the video AU read for decoding in step S211 (that is, the video AU input to the video decoder 27) is the starting video AU of the segment and the value of the scene change detection flag stored in the control unit 22 is 1.

In a case where it is determined in step S214 that the processing target video AU is not the starting video AU or the value of the scene change detection flag is not 1, the flow proceeds to step S218.

In contrast, in a case where it is determined in step S214 that the processing target video AU is the starting video AU and the value of the scene change detection flag is 1, the video decoder 27 determines whether or not the video frame is in the effect period in step S215.

For example, in step S215, it is determined whether the video frame is in the effect period similarly to step S84 in FIG. 5 on the basis of the display time point t of the video AU input to the video decoder 27 and the effect starting time point ts and the effect period length d stored in the control unit 22.

In a case where it is determined in step S215 that the video frame is in the effect period, since it is not necessary to store the last frame, the flow proceeds to step S218.

In contrast, in a case where it is determined in step S215 that the video frame is not in the effect period, the video decoder 27 sets the display time point t of the video AU read in step S211 (that is, the value of CTS) to the effect starting time point ts and supplies the effect starting time point ts to the control unit 22 in step S216.

In step S217, the video decoder 27 supplies a video frame output first after a video AU is input in step S211 to the still image buffer 30 via the switch 28 as a last frame so that the video frame is stored therein.

In this case, since the video AU input to the video decoder 27 is the starting video AU of a segment, the video frame output first after the input is the frame that is the last in time of the previous segment.

Furthermore, since only the last video frame of a segment that is outside an effect period and immediately before a scene change is stored as the last frame, it is not necessary to store an unnecessary last frame and it is possible to suppress a load such as the number of processes.

When the last frame is stored in this manner, the flow proceeds to step S218, the processes of steps S218 to S220 are performed, and the video decoding process ends. Note that the processes of steps S218 to S220 are similar to the processes of steps S124 to S126 in FIG. 6, and the description thereof will be omitted.

In this manner, the client apparatus 11 supplies the last frame to the still image buffer 30 by taking the delay of the video decoder 27 into consideration. In this way, it is possible to execute a video transition effect more easily (that is, with a smaller number of processes) using the last frame and to suppress disharmony during switching of display.

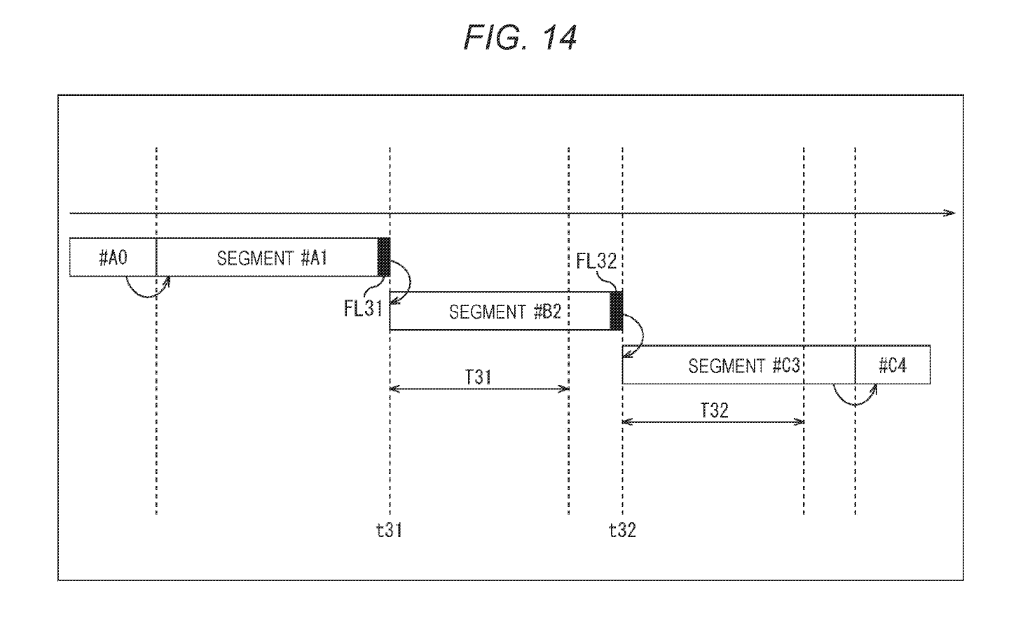

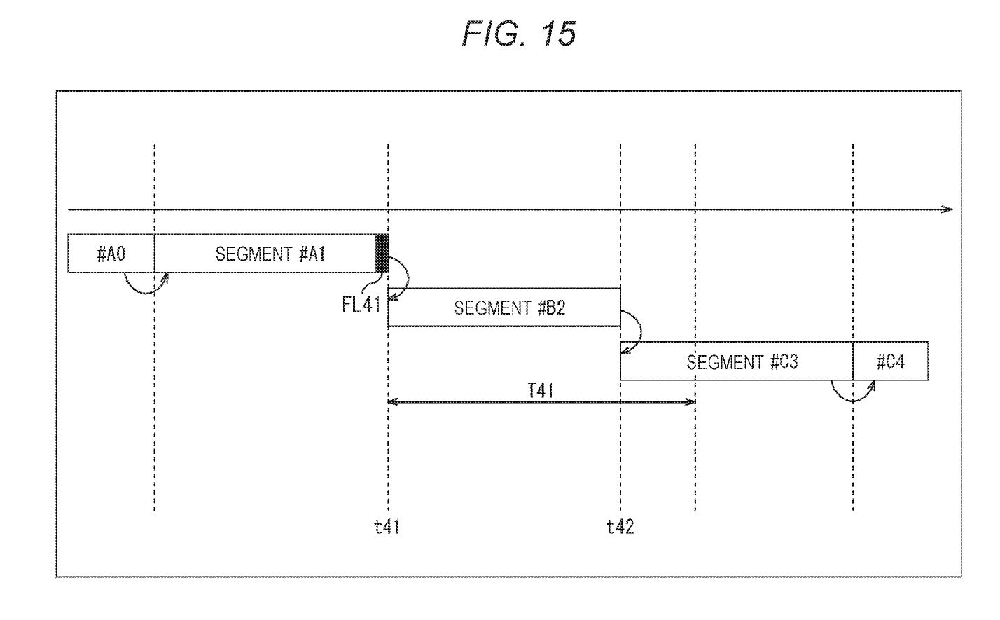

In the second embodiment described hereinabove, the last frame necessary for the video transition effect only is stored in the client apparatus 11. Then, as illustrated in FIGS. 14 and 15, for example, display switching and the video transition effect are executed. Note that, in FIGS. 14 and 15, the portions corresponding to those of FIGS. 10 and 11 will be denoted by the same reference numerals, and the description thereof will be omitted appropriately.

For example, in FIG. 14, video segment data of Segment#A0 and Segment#A1 is downloaded to reproduce contents.

In this case, in the boundary between Segment#A0 and Segment#A1 in which a scene change does not occur (that is, the value of the scene change detection flag is 0), the last frame is not supplied to the still image buffer 30. That is, the last video frame of Segment#A0 is not stored in the still image buffer 30.

On the other hand, when switching of representations including transition of adaptation sets occurs at time point t31, video segment data of Segment#B2 of a representation different from the preceding representations is downloaded, and display switching and a video transition effect are executed.

In this case, when the starting video AU of Segment#B2 is input to the video decoder 27, the video decoder 27 stores the last video frame of Segment#A1 output at that time in the still image buffer 30 as the last frame FL31.

Moreover, in the period T31 used as the effect period, same as that described with reference to FIG. 10, a presentation video frame is generated and displayed by a video transition effect process using the last frame FL31 and the video frame of each time point of Segment#B2.

Then, when the effect period ends, the video frame of each time point of Segment#B2 is displayed as the presentation video frame as it is. In this example, the period T31 is set to a period having a length shorter than the segment length.

Moreover, when switching of representations including transition of adaptation sets occurs at time point t32, video segment data of Segment#C3 is downloaded, and display switching and a video transition effect are executed.

In this case, when the starting video AU of Segment#C3 is input to the video decoder 27, the video decoder 27 stores the last video frame of Segment#B2 output at that time in the still image buffer 30 as the last frame FL32.

Furthermore, after that, although the video segment data of Segment#C4 subsequently to Segment#C3 is downloaded, since a scene change does not occur in the boundary between Segment#C3 and Segment#C4, the last frame is not supplied to the still image buffer 30.

Moreover, for example, in the example illustrated in FIG. 15, first, the video segment data of Segment#A0 and Segment#A1 is downloaded to reproduce contents.

In this example, since a scene change does not occur in the boundary between Segment#A0 and Segment#A1, the last frame is not stored.

After that, when switching of representations including transition of adaptation sets occurs at time point t41, video segment data of Segment#B2 is downloaded, and display switching and a video transition effect are executed.

In this case, when the starting video AU of Segment#B2 is input to the video decoder 27, similarly to the case of FIG. 14, the last video frame of Segment#A1 is stored as the last frame FL41.

Moreover, although representations are switched at time point t42 and the video segment data of Segment#C3 is downloaded, in this example, the effect period is longer than the segment length, and a part of Segment#C3 is included in the period T41.

Therefore, in a partial section of Segment#C3, a presentation video frame is generated and displayed by a video transition effect process using the last frame FL41 and the video frame of each time point of the partial section.

Furthermore, although the video segment data of Segment#C4 subsequently to Segment#C3 is downloaded, since a scene change does not occur in the boundary between Segment#C3 and Segment#C4, the last frame is not supplied to the still image buffer 30.

As illustrated in FIGS. 14 and 15, in the second embodiment, the effect period length d may be shorter or longer than the segment length, and in any case, it is possible to switch the display from a source moving image to a destination moving image smoothly.

### Third Embodiment

<About Representative Frame>

By the way, in the above-description, an example in which the video frame that is the last in time of a segment is stored in the still image buffer 30 has been described. However, an arbitrary video frame in a segment may be used as a representative frame, and the representative frame may be used for the video transition effect. In this case, the position of the representative frame may be different for respective segments.

Hereinafter, an example in which a representative frame in a segment is used for the video transition effect will be described.

For example, in a case where a video transition effect is executed using a last frame of a still image and a video frame of a moving image, a video frame that is the last in time of a video segment is used continuously in the effect period.

In this case, although it is determined that the last video frame of a schematic diagram is to be used, it is not always limited that the last video frame of a segment is appropriate to be used for the video transition effect. That is, it is different depending on a case that the emotional value of the last video frame of a segment is sufficient.

A typical example is the look of a person, or the like. Although it is not always true that the smiling face has a high emotional value in sports contents or the like, a scene in which an artist sings with a smiling face often has a high emotional value in music contents or the like. When the last video frame of a segment is used for a video transition effect, it cannot be said that the video frame is a frame (that is, a most suitable frame) having the highest emotional value near the terminating end of the segment.

Although it is difficult to perform weighting of an emotional value of a video frame which is a portion extracted from contents by a generalized process, it is not difficult for a contents maker to prepare an evaluation index.

Therefore, for example, a contents maker evaluates the emotional value of each video frame in a section near the terminating end of a segment so that the client apparatus 11 can select an appropriate representative frame on the basis of the evaluation result.

In this case, a video frame that represents a segment, having a high emotional value among a plurality of video frames that form the segment is used as a representative frame.

For example, as a specific implementation example, a contents maker may select a video frame having a high emotional value using a face recognition engine and store the selection result in the segment data.

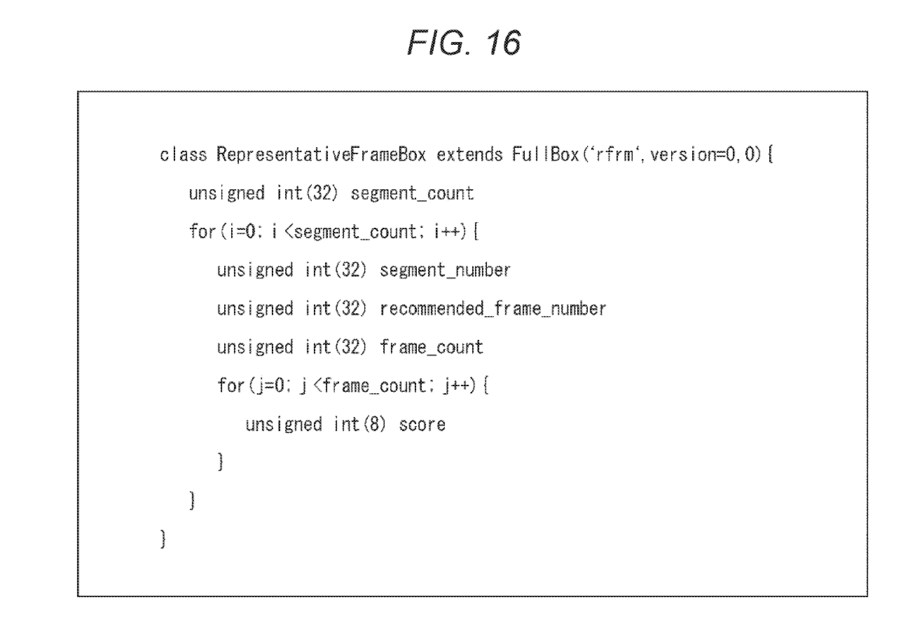

For this, first, it is necessary to store information (that is, information related to a video frame that represents a segment; hereinafter this information will be referred to as representative frame information) related to an emotional value of a video frame in units of segments, and the representative frame information may be stored in a MP4 file. For example, the representative frame information may be stored in the MP4 file in a data structure illustrated in FIG. 16.

In the example illustrated in FIG. 16, “segment_count” indicates the number of segments included in a contents stream, and information corresponding to the number of segments is stored in the subsequent portion of the “segment_count”.

“segment_number” indicates a segment number for identifying a segment. For example, in the case of Live-profile, since one segment is one MP4 file, it may be set such that segment_count=1 and segment_number=0xFFFFFFFF. On the other hand, in the case of On-demand profile, since a plurality of sub-segments are included in one MP4 file, it is generally set such that segment_count>1.

“recommended_frame_number” indicates a frame number (hereinafter also referred to as a recommended frame number) of a video frame recommended by a contents maker among video frames that form a segment. The recommended frame number is information indicating a video frame that represents a segment (that is, a video frame which has a high emotional value and is recommended as a representative frame by a contents maker.

For example, as for a frame number of a video frame, a starting frame in a segment in the CTS order is set as the 0-th frame in the case of Live-profile, and a starting frame in a sub-segment in the CTS order is set as the 0-th frame in the case of On-demand profile. In a case where a recommended frame is not necessary, the value of recommended_frame_number is set to 0xFFFFFFFF.

Moreover, the representative frame information includes an emotional score indicating an evaluation value of an emotional value of a video frame for the successive last several frames of the segment in addition to the recommended frame number. That is, the emotional score is a score indicating the emotional value of a video frame. In other words, the emotional score is a score indicating the degree of appropriateness in a case where the video frame is used as a representative frame.

In the following description, the number of video frames to which an emotional score is appended (that is, in which the emotional score is calculated) will be referred to as the number of evaluation frame s, and a section including frames corresponding to the number of successive evaluation frames including the terminating end of a segment will be referred to as an evaluation section.

In FIG. 16, “frame_count” indicates the number of evaluation frames, and “score” indicates the emotional score. In this example, emotional scores corresponding to the number of evaluation frames are stored in the representative frame information. Moreover, for example, the emotional score has an integer value of between 0 and 100, and the higher the value, the higher the emotional score and the higher the emotional value.

For example, in the contents maker side, the representative frame information is generated in this manner and the representative frame information is stored in the MP4 file.

That is, first, for all video frames in a segment, a face recognition process or the like is performed on a video frame to calculate an emotional score of the video frame, and a frame number of a video frame having the highest emotional score is identified. Then, when the video frame of the identified frame number is a frame outside the evaluation section, the frame number is used as a recommended frame number. When the video frame of the identified frame number is a frame in the evaluation section, the recommended frame number is set to 0xFFFFFFFF.

Here, when the emotional score is calculated, the degree of smiling face (that is, the degree of smiling) of a person in the video frame is calculated on the basis of the result of the face recognition process, for example, and the degree of smiling is used as the emotional score.

When the recommended frame number is obtained for each segment, the number of segment segment_count is stored in the MP4 file, and after that, the segment number segment_number, the recommended frame number recommended_frame_number, the number of evaluation frames frame_count, and the emotional score score of each video frame of the evaluation section are stored for each segment and are used as the representative frame information. The MP4 file obtained in this manner is stored in the video segment data and is transmitted to the client apparatus 11.

For example, when a representative frame is selected for a video transition effect, if a video frame of a face in the middle of eye-blinking or the like is selected as a representative frame, the emotional value or the emotional score of the video may decrease.

Therefore, a contents maker allocates a sufficient time for avoiding a video including an eye-blinking, for example, as a selection range of a representative frame to be stored in the still image buffer 30. Generally, the speed of one instance of eye-blinking is approximately 100 to 150 milliseconds, and this corresponds to a display time of approximately 6 to 9 frames in the case of 60-Hz video. Therefore, in this example, the emotional scores of the last ten frames of a segment are recorded for a 60-Hz video. That is, in this case, the number of evaluation frames is set to 10 frames.

Note that the representative frame information may be stored in any location such as a video AU as long as it is within the stream in which the moving image data is stored without being limited to the MP4 file. Moreover, the representative frame information may be supplied from an external device to the client apparatus 11 and the representative frame information may be described in the MPD file.

On the other hand, in the client apparatus 11, the MP4 file is read from the downloaded video segment data by the MP4 parser 25. That is, the MP4 parser 25 extracts the recommended frame number or the emotional score for the segment from the representative frame information in the MP4 file read from the video track buffer 24 and determines the representative frame in units of segments (that is, for each segment).

For example, the MP4 parser 25 reads the number of evaluation frames from the representative frame information to identify the length of the evaluation section and reads the emotional score of each video frame of the evaluation section from the representative frame information. In this case, the MP4 parser 25 identifies a video frame having the highest emotional score and temporarily stores the identification result.

Moreover, the MP4 parser 25 reads the recommended frame number from the representative frame information and sets a video frame having the highest emotional score as a representative frame in a case where the recommended frame number is 0xFFFFFFFF (that is, there is no recommended frame and the recommended frame number has an invalid value).

In contrast, in a case where the recommended frame number is not 0xFFFFFFFF (that is, the recommended frame number has a valid value), the MP4 parser 25 determines whether or not the video frame of the recommended frame number is included in a valid section including a prescribed number of successive frames including the terminating end of the segment.

Here, the valid section may be the same as the evaluation section and may be set as a section having a different length from the evaluation section. For example, the valid section is set as a section of the last twenty frames of the segment, or the like.

When it is determined that the video frame of the recommended frame number is a frame outside the valid section, the MP4 parser 25 sets a video frame having the highest emotional score among the video frames in the evaluation section as the representative frame. That is, the representative frame is determined on the basis of the emotional score.

Although the video frame of the recommended frame number is a frame recommended by the contents maker, in a case where the video frame is not in the vicinity of the terminating end of a segment, it cannot be said that the video frame of the recommended frame number is optimal as the representative frame. Therefore, when the video frame of the recommended frame number is outside the valid section, a video frame having the highest emotional score is used as the representative frame.

Moreover, when it is determined that the video frame of the recommended frame number is a frame in the valid section, the MP4 parser 25 uses the video frame of the recommended frame number as the representative frame. That is, the representative frame is determined on the basis of the recommended frame number.

In a case where the representative frame information is not present, in a case where the highest emotional score is equal to or smaller than a threshold, in a case where a representative frame is determined in advance, or the like, the MP4 parser 25 may set a frame that is the last in time of a segment as the representative frame. In this manner, the MP4 parser 25 functions as a representative frame determining unit that determines a representative frame among a plurality of frames that form each segment on the basis of the representative frame information acquired (read) from the MP4 file.

Furthermore, the control unit 22 of the client apparatus 11 may control the face recognition engine to perform a face recognition process on the basis of the video segment data, calculate the emotional score of each video frame in the evaluation section, and select the representative frame from the calculation result.

<Description of Video Segment Process>

In the above-described manner, in a case where the client apparatus 11 receives (acquires) the MP4 file including the representative frame information from the server, the client apparatus 11 performs the streaming reproduction process described with reference to FIG. 3. Then, in step S17 of the streaming reproduction process, the video segment downloading process described with reference to FIG. 4 is performed.

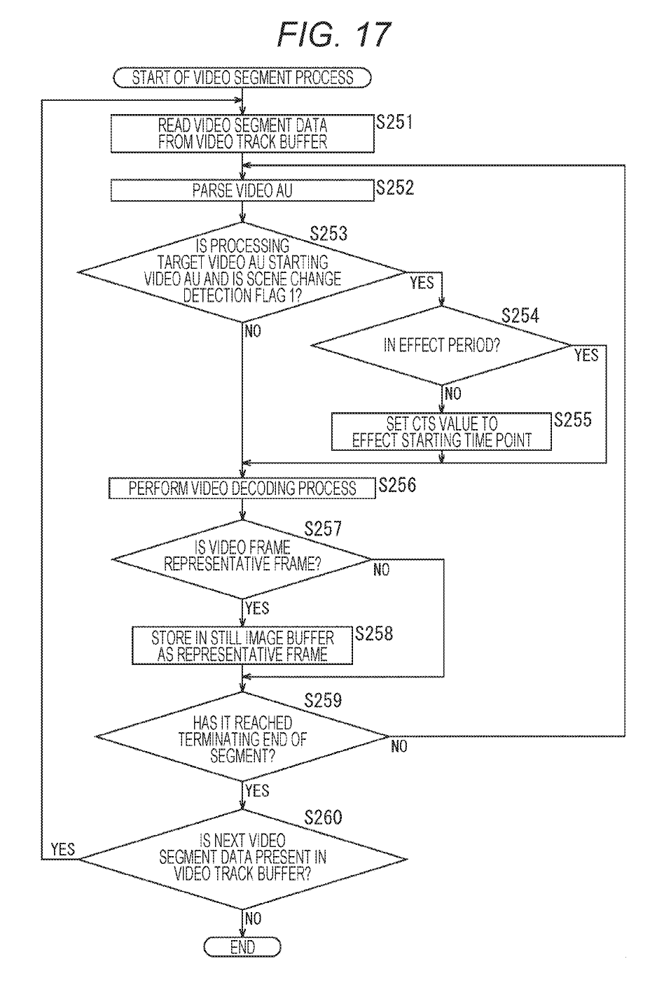

However, in step S56 of the video segment downloading process, the video segment process illustrated in FIG. 17 rather than the video segment process described with reference to FIG. 5 is performed.

Hereinafter, the video segment process performed by the client apparatus 11 in correspondence to the process of step S56 in FIG. 4 will be described with reference to the flowchart of FIG. 17. Note that the processes of steps S251 to S256 are similar to the processes of steps S81 to S86 in FIG. 5, and the detailed description thereof will be omitted.

However, in step S252, the MP4 parser 25 parses the video AU and reads the representative frame information of the video segment data read in the process of step S251 from the MP4 file.

Then, the MP4 parser 25 performs the above-described process on the basis of the number of evaluation frames, the recommended frame number, the emotional score, and the like included in the representative frame information to determine the representative frame. The determination result of the representative frame is supplied from the MP4 parser 25 to the video decoder 27 via the control unit 22.

Moreover, in step S256, the video decoding process described with reference to FIG. 6 is performed. In this case, in step S125 of FIG. 6, the video transition effect execution process described with reference to FIG. 7 is performed. In this video transition effect execution process, a video transition effect process is performed using the representative frame stored in the still image buffer 30 as a still image.

In step S257, the video decoder 27 determines whether or not the video frame obtained by decoding the processing target video AU is a representative frame on the basis of the determination result of the representative frame supplied from the control unit 22.

In a case where it is determined in step S257 that the video frame is a representative frame, the video decoder 27 supplies the video frame obtained by decoding the processing target video AU to the still image buffer 30 via the switch 28 so that the video frame is stored as the representative frame in step S258.

When the representative frame is stored, the flow proceeds to step S259.

Moreover, in a case where it is determined in step S257 that the video frame is not the representative frame, the flow proceeds to step S259 without performing the process of step S258.

In a case where the process of step S258 is performed or in a case where it is determined in step S257 that the video frame is not the representative frame, the MP4 parser 25 determines whether or not the terminating end of a segment has been reached in step S259.

In a case where it is determined in step S259 that the terminating end of a segment has not been reached, the flow returns to step S252 and the above-described process is performed repeatedly.

In contrast, in a case where it is determined in step S259 that the terminating end of the segment has been reached, the MP4 parser 25 determines whether or not video segment data subsequent to the video segment data read in step S251 is present in the video track buffer 24 in step S260.

In a case where it is determined in step S260 that the subsequent video segment data is present, the flow returns to step S251, and the above-described process is performed repeatedly.

In contrast, in a case where it is determined in step S260 that the subsequent video segment data is not present, the video segment process ends.

In this manner, the client apparatus 11 determines the representative frame on the basis of the representative frame information and stores the representative frame in the still image buffer 30. In this way, it is possible to execute a video transition effect more easily (that is, with a smaller number of processes) using the video frame (representative frame) stored in the still image buffer 30 and to suppress disharmony during switching of display.

Note that the present technology described hereinabove can be applied to switching of representations in the same adaptation set which is generally performed in MPEG-DASH streaming reproduction since it is not necessary to download different pieces of video segment data having the same viewpoint redundantly.

<Configuration Example of Computer>

Incidentally, the above-mentioned series of processes may be executed using hardware or may be executed using software. In a case in which the series of processes is executed using software, a program that configures the software is installed on a computer. In this instance, as a computer, it is possible to include a computer that is included in dedicated hardware, a general use personal computer that is capable of executing various functions due to various programs being installed thereon, and the like.

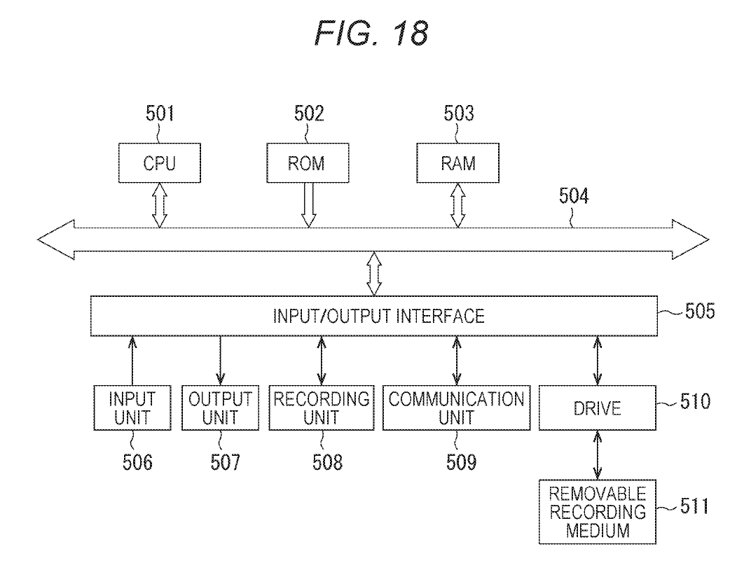

FIG. 18 is a block diagram that shows a configuration example of hardware of a computer that executes the above-mentioned series of processes using a program.

In the computer, a central processing unit (CPU) 501, a read only memory (ROM) 502, and a random access memory (RAM) 503 are mutually connected by a bus 504.

An input/output interface 505 is further connected to the bus 504. An input unit 506, and output unit 507, a recording unit 508, a communication unit 509 and a drive 510 are connected to the input/output interface 505.

The input unit 506 includes a keyboard, a mouse, a microphone, an imaging element or the like. The output unit 507 includes a display, a speaker or the like. The recording unit 508 includes a hard disk, non-volatile memory or the like. The communication unit 509 includes a network interface or the like. The drive 510 drives the removable recording medium 511 such as a magnetic disk, an optical disc, a magneto optical disc or semiconductor memory.

In a computer that is configured in the above-mentioned manner, the above-mentioned series of processes is performed by, for example, the CPU 501 loading a program recorded on the recording unit 508 into the RAM 503 via the input/output interface 505 and the bus 504 and executing the program.

A program executed by the computer (the CPU 501) can be provided by being recorded on a removable recording medium 511 as a package medium or the like, for example. In addition, the program can be provided through a wired or wireless transmission medium such as a local area network, the Internet, or a digital satellite broadcast.

In the computer, the program can be installed on the recording unit 508 through the input/output interface 505 by mounting the removable recording medium 511 into the drive 510. In addition, the program can be received by the communication unit 509 through a wired or wireless transmission medium and installed on the recording unit 508. In addition to this, the program can be installed on the ROM 502 or the recording unit 508 in advance.

Note that the program that the computer executes maybe a program in which the processes are performed in time sequence in the order that is described in the present specification, or may be a program in which the processes are performed in parallel or at a required timing such as when an alert is performed.

In addition, the embodiment of the present technology is not limited to the above-mentioned embodiment, and various alterations are possible within a range that does not depart from the scope of the present technology.

For example, the present technology can have a cloud computing configuration in which a single function is shared and processed in cooperation among a plurality of apparatuses through a network.

Further, in addition to being executed by a single apparatus, each step that is described in the above-mentioned flowchart can be executed by being assigned to a plurality of apparatuses.

Furthermore, in a case in which a plurality of processes are included in a single step, in addition to being executed by a single apparatus, the plurality of processes that are included in the single step can be executed by being assigned to a plurality of apparatuses.

Moreover, the effects described in this specification are merely illustrative and are not limitative, and may include other effects.

Furthermore, the present technology may be configured as below.

(1)

An image processing device including:

a moving image generating unit that generates moving image data of a transition moving image in which display transitions from a prescribed frame to a second moving image on the basis of the prescribed frame that forms a first moving image and moving image data of the second moving image in a case where display is switched from the first moving image to the second moving image.

(2)

The image processing device according to (1), further including:

a decoder that decodes the moving image data of the first moving image and the second moving image;

a first storage unit that stores the prescribed frame obtained by the decoding; and

a second storage unit that stores frames of the first moving image or the second moving image obtained by the decoding.

(3)

The image processing device according to (2), in which

the moving image generating unit uses a last frame in time before switching of the first moving image as the prescribed frame.

(4)

The image processing device according to (3), in which

the decoder stores a last frame of the first moving image of a prescribed time unit in the first storage unit as the prescribed frame in a period other than an effect period in which the moving image data of the transition moving image is generated for the first moving image of the prescribed time unit.

(5)

The image processing device according to (2), in which

the decoder stores a frame of the first moving image output first after a predetermined frame of the second moving image is input in the first storage unit as the prescribed frame.

(6)

The image processing device according to any one of (1) to (5), in which

the moving image generating unit generates the moving image data of the transition moving image in which display transitions from the prescribed frame to the second moving image more abruptly on a starting side than an ending side.

(7)

The image processing device according to (1) or (2), further including:

a representative frame determining unit that determines a representative frame among a plurality of frames that forms the first moving image on the basis of information related to an emotional value of the first moving image, in which

the moving image generating unit uses the representative frame as the prescribed frame.

(8)

The image processing device according to (7), in which

the representative frame determining unit determines the representative frame on the basis of a score indicating an emotional value of frames of the first moving image as the information related to the emotional value.

(9)

The image processing device according to (7) or (8), in which

the representative frame determining unit determines the representative frame on the basis of recommended frame information indicating a frame recommended as the representative frame of the first moving image as the information related to the emotional value.

(10)

The image processing device according to (9), in which

the representative frame determining unit determines the representative frame in a prescribed time unit for the first moving image, and

in a case where a frame indicated by the recommended frame information is a frame outside a valid period including a terminating end of the first moving image of the prescribed time unit, the representative frame determining unit determines the representative frame from frames within a period including successive frames including the terminating end of the first moving image of the prescribed time unit on the basis of a score indicating an emotional value of frames of the first moving image as the information related to the emotional value.

(11)

The image processing device according to any one of (7) to (10), in which

the representative frame determining unit acquires information related to the emotional value from a stream in which moving image data of the first moving image is stored.

(12)

An image processing method including:

a step of generating moving image data of a transition moving image in which display transitions from a prescribed frame to a second moving image on the basis of the prescribed frame that forms a first moving image and moving image data of the second moving image in a case where display is switched from the first moving image to the second moving image.

(13)

A program for causing a computer to execute:

a process including a step of generating moving image data of a transition moving image in which display transitions from a prescribed frame to a second moving image on the basis of the prescribed frame that forms a first moving image and moving image data of the second moving image in a case where display is switched from the first moving image to the second moving image.

### REFERENCE SIGNS LIST

11 Client apparatus
22 Control unit
23 Downloader
24 Video track buffer
25 MP4 parser
26 Video AU buffer
27 Video decoder
29 Video frame buffer
30 Still image buffer
31 Video cross-fader

1. An image processing device comprising:
a decoder that decodes moving image data of a first moving image and a second moving image;
a first storage unit that stores a prescribed frame that forms the first moving image obtained by the decoding;
a second storage unit that stores frames of the first moving image or the second moving image obtained by the decoding;
a moving image generating unit that generates moving image data of a transition moving image in which display transitions from the prescribed frame to the second moving image on a basis of the prescribed frame and the moving image data of the second moving image in a case where display is switched from the first moving image to the second moving image, wherein
the decoder stores a frame of the first moving image output first after a predetermined frame of the second moving image is input in the first storage unit as the prescribed frame.

2. (canceled)

3. (canceled)

4. (canceled)

5. (canceled)

6. The image processing device according to claim 1, wherein
the moving image generating unit generates the moving image data of the transition moving image in which display transitions from the prescribed frame to the second moving image more abruptly on a starting side than an ending side.

7. An image processing device comprising:
a representative frame determining unit that determines a representative frame among a plurality of frames that forms a first moving image on a basis of information related to an emotional value of the first moving image; and
a moving image generating unit that generates moving image data of a transition moving image in which display transitions from the representative frame to a second moving image on a basis of the representative frame and moving image data of the second moving image in a case where display is switched from the first moving image to the second moving image.

8. The image processing device according to claim 7, wherein
the representative frame determining unit determines the representative frame on a basis of a score indicating an emotional value of frames of the first moving image as the information related to the emotional value.

9. The image processing device according to claim 7, wherein
the representative frame determining unit determines the representative frame on a basis of recommended frame information indicating a frame recommended as the representative frame of the first moving image as the information related to the emotional value.

10. The image processing device according to claim 9, wherein
the representative frame determining unit determines the representative frame in a prescribed time unit for the first moving image, and
in a case where a frame indicated by the recommended frame information is a frame outside a valid period including a terminating end of the first moving image of the prescribed time unit, the representative frame determining unit determines the representative frame from frames within a period including successive frames including the terminating end of the first moving image of the prescribed time unit on a basis of a score indicating an emotional value of frames of the first moving image as the information related to the emotional value.

11. The image processing device according to claim 7, wherein
the representative frame determining unit acquires information related to the emotional value from a stream in which moving image data of the first moving image is stored.

12. An image processing method comprising:
a step of allowing a decoder to decode moving image data of a first moving image and a second moving image;
storing a frame of the first moving image output first from the decoder after a predetermined frame of the second moving image obtained by the decoding is input to the decoder, in a first storage unit as a prescribed frame;
storing frames of the first moving image or the second moving image obtained by the decoding in a second storage unit; and
generating moving image data of a transition moving image in which display transitions from the prescribed frame to the second moving image on a basis of the prescribed frame and the moving image data of the second moving image in a case where display is switched from the first moving image to the second moving image.

13. A program for causing a computer to execute:
a process including a step of allowing a decoder to decode moving image data of a first moving image and a second moving image;
storing a frame of the first moving image output first from the decoder after a predetermined frame of the second moving image obtained by the decoding is input to the decoder, in a first storage unit as a prescribed frame;
storing frames of the first moving image or the second moving image obtained by the decoding in a second storage unit; and
generating moving image data of a transition moving image in which display transitions from the prescribed frame to the second moving image on a basis of the prescribed frame and the moving image data of the second moving image in a case where display is switched from the first moving image to the second moving image.

14. An image processing method comprising:
a step of determining a representative frame among a plurality of frames that forms a first moving image on a basis of information related to an emotional value of the first moving image; and
generating moving image data of a transition moving image in which display transitions from the representative frame to a second moving image on a basis of the representative frame and moving image data of the second moving image in a case where display is switched from the first moving image to the second moving image.

15. A program for causing a computer to execute a process including a step of:
determining a representative frame among a plurality of frames that forms a first moving image on a basis of information related to an emotional value of the first moving image; and
generating moving image data of a transition moving image in which display transitions from the representative frame to a second moving image on a basis of the representative frame and moving image data of the second moving image in a case where display is switched from the first moving image to the second moving image.
